(19) United States
(12) Patent Application Publication
(10) Pub. No.: US 2025/0119958 A1
(43) Pub. Date: Apr. 10, 2025

(54) DIGITAL REPRESENTATION OF USER EQUIPMENT RECEIVER FOR COMMUNICATION CHANNEL ADAPTATION

(71) Applicant: QUALCOMM Incorporated, San Diego, CA (US)

(72) Inventors: Jacob PICK, Mevaseret Zion (IL); Shay LANDIS, Hod Hasharon (IL); Peer BERGER, Hod Hasharon (IL); Gideon Shlomo KUTZ, Ramat Hasharon (IL); Tomer GEVA, Kiryat Ono (IL)

(21) Appl. No.: 18/481,788

(22) Filed: Oct. 5, 2023

(51) Int. Cl. H04W 76/10; H04L 25/02

(52) U.S. Cl. CPC H04W 76/10; H04L 25/0256

(57) ABSTRACT

Certain aspects of the present disclosure provide techniques for simulating a receiver for link adaptation. A method for wireless communications by an apparatus includes obtaining, from an UE, parameters of a UE receiver; determining channel characteristics of a communication channel between the apparatus and the UE based on a measurement of a signal received from the UE; estimating a response of the UE receiver communicating on the communication channel having the channel characteristics based on a digital representation of the UE receiver, wherein the digital representation of the UE receiver is based on the parameters of the UE receiver; determining, based on the estimated response, at least one parameter for communication on the communication channel with the UE; sending, to the UE, an indication of the at least one parameter; and communicating with the UE in accordance with the at least one parameter.

### INTRODUCTION

### Field of the Disclosure

Aspects of the present disclosure relate to wireless communications, and more particularly, to techniques for communication channel adaptation.

### DESCRIPTION OF RELATED ART

Wireless communications systems are widely deployed to provide various telecommunication services such as telephony, video, data, messaging, broadcasts, or other similar types of services. These wireless communications systems may employ multiple-access technologies capable of supporting communications with multiple users by sharing available wireless communications system resources with those users.

Although wireless communications systems have made great technological advancements over many years, challenges still exist. For example, complex and dynamic environments can still attenuate or block signals between wireless transmitters and wireless receivers. Accordingly, there is a continuous desire to improve the technical performance of wireless communications systems, including, for example: improving speed and data carrying capacity of communications, improving efficiency of the use of shared communications mediums, reducing power used by transmitters and receivers while performing communications, improving reliability of wireless communications, avoiding redundant transmissions and/or receptions and related processing, improving the coverage area of wireless communications, increasing the number and types of devices that can access wireless communications systems, increasing the ability for different types of devices to intercommunicate, increasing the number and type of wireless communications mediums available for use, and the like. Consequently, there exists a need for further improvements in wireless communications systems to overcome the aforementioned technical challenges and others.

### SUMMARY

One aspect provides a method for wireless communications by an apparatus. The method includes obtaining, from a user equipment (UE), one or more parameters of a UE receiver; determining one or more channel characteristics of a communication channel between the apparatus and the UE based on a measurement of a signal received from the UE; estimating a response of the UE receiver communicating on the communication channel having the one or more channel characteristics based on a digital representation of the UE receiver, wherein the digital representation of the UE receiver is based on the one or more parameters of the UE receiver; determining, based on the estimated response, at least one parameter for communication on the communication channel with the UE; sending, to the UE, an indication of the at least one parameter; and communicating with the UE in accordance with the at least one parameter.

Another aspect provides a method for wireless communications by an apparatus. The method includes sending one or more parameters of a UE receiver, the one or more parameters indicating a digital representation of the UE receiver used to estimate a response of the UE receiver communicating on a communication channel having one or more channel characteristics; receiving at least one parameter for communicating on the communication channel, the at least one parameter based at least in part on the one or parameters and the one or more channel characteristics of the communication channel; and communicating on the communication channel in accordance with the at least one parameter.

Other aspects provide: one or more apparatuses operable, configured, or otherwise adapted to perform any portion of any method described herein (e.g., such that performance may be by only one apparatus or in a distributed fashion across multiple apparatuses): one or more non-transitory, computer-readable media comprising instructions that, when executed by one or more processors of one or more apparatuses, cause the one or more apparatuses to perform any portion of any method described herein (e.g., such that instructions may be included in only one computer-readable medium or in a distributed fashion across multiple computer-readable media, such that instructions may be executed by only one processor or by multiple processors in a distributed fashion, such that each apparatus of the one or more apparatuses may include one processor or multiple processors, and/or such that performance may be by only one apparatus or in a distributed fashion across multiple apparatuses), one or more computer program products embodied on one or more computer-readable storage media comprising code for performing any portion of any method described herein (e.g., such that code may be stored in only one computer-readable medium or across computer-readable media in a distributed fashion); and/or one or more apparatuses comprising one or more means for performing any portion of any method described herein (e.g., such that performance would be by only one apparatus or by multiple apparatuses in a distributed fashion). By way of example, an apparatus may comprise a processing system, a device with a processing system, or processing systems cooperating over one or more networks.

The following description and the appended figures set forth certain features for purposes of illustration.

### BRIEF DESCRIPTION OF DRAWINGS

The appended figures depict certain features of the various aspects described herein and are not to be considered limiting of the scope of this disclosure.

FIG. 1 depicts an example wireless communications network.

FIG. 2 depicts an example disaggregated base station architecture.

FIG. 3 depicts aspects of an example base station and an example user equipment (UE).

FIGS. 4A, 4B, 4C, and 4D depict various example aspects of data structures for a wireless communications network.

FIG. 5 is a diagram illustrating an example receiver in communication with a transmitter over a communication channel.

FIG. 6 depicts a process flow for closed-loop feedback associated with a communication channel in a network between a network entity and a UE.

FIG. 7 is a diagram illustrating an example artificial intelligence (AI) architecture that may be used for AI-enhanced wireless communications.

FIG. 8 is a diagram illustrating an example of UE receiver response prediction by a network entity.

FIG. 9 is an illustrative diagram of an example artificial neural network (ANN).

FIG. 10 is a diagram illustrating an example mapping scheme that maps a receiver architecture to various types of signal decoding operations used at a UE receiver.

FIG. 11 depicts a process flow for communications in a network between a network entity and an UE.

FIG. 12 depicts a method for wireless communications.

FIG. 13 depicts another method for wireless communications.

FIG. 14 depicts aspects of an example communications device.

FIG. 15 depicts aspects of an example communications device.

### DETAILED DESCRIPTION

Aspects of the present disclosure provide apparatuses, methods, processing systems, and computer-readable mediums for simulating a response of a user equipment receiver for link adaptation.

In certain wireless communication systems, closed-loop feedback associated with a communication channel may be used to dynamically adapt to time varying channel conditions, for example, due to changes with respect to user equipment (UE) mobility, weather conditions, scattering, fading, interference, noise, etc. For example, a UE may report channel state feedback (CSF) to a network entity, which may adjust certain communication parameters in response to the feedback from the UE. For example, link adaptation (such as adaptive modulation and coding) with various modulation schemes and channel coding rates may be applied to certain communication channels. For channel state estimation purposes, the UE may be configured to measure a reference signal and estimate the channel state based on measurements of that reference signal. The UE may report an estimated channel state to the network entity in the form of CSF, which may be used in link adaptation. The CSF may indicate channel properties of a communication link between the network entity and the UE. The CSF may indicate the effect of, for example, scattering, fading, and pathloss of a signal propagating across the communication link. As an example, a CSF report may include one or more of a channel quality indicator (CQI), a precoding matrix indicator (PMI), a layer indicator (LI), a rank indicator (RI), a reference signal received power (RSRP), a signal-to-interference plus noise ratio (SINR), etc. Additional or other information may be included in a CSF report.

Technical problems for link adaptation include, for example, the overhead of communicating the CSF from the UE to the network entity and the reporting rate of the CSF. As the CSF carries information on the channel state, the overhead of the CSF occupies valuable communication channel resources that could be used for carrying, for example, user-plane traffic or other traffic. For example, the PMI may indicates the UE's preferred precoder (e.g., beamforming) for the network entity to use for downlink transmissions. The PMI may include precoding information at various levels of resolutions across a spatial domain and frequency domain. For example, the PMI may include a plethora of precoding information (e.g., weighted combinations of beams with relative amplitudes and co-phasing phase shifts) associated with multiple beams, multiple bandwidths (wideband and/or subband reporting stages), multiple multiple-input and multiple-output (MIMO) layers, etc. The PMI and corresponding RI can occupy the bulk of the CSF reported from the UE.

The tracking rate (e.g., the rate at which the communication link is adapted to changing channel conditions) may depend on the reporting rate of the CSF. For example, the network entity may be unaware of rapidly changing channel conditions encountered at a UE due to a relatively long periodicity between consecutive CSF reports, and the network entity may be unable to respond to such changing channel conditions without impacting the performance of the communication link between the network entity and the UE. Moreover, adjusting the CSF reporting rate affects the tracking rate, for example, to adapt to rapidly changing channel conditions, and an adjustment on the CSF reporting rate impacts the overhead of the CSF. For example, a reduced periodicity for CSF reporting to satisfy rapidly changing channel conditions can equate to more signaling overhead used for the CSF reporting.

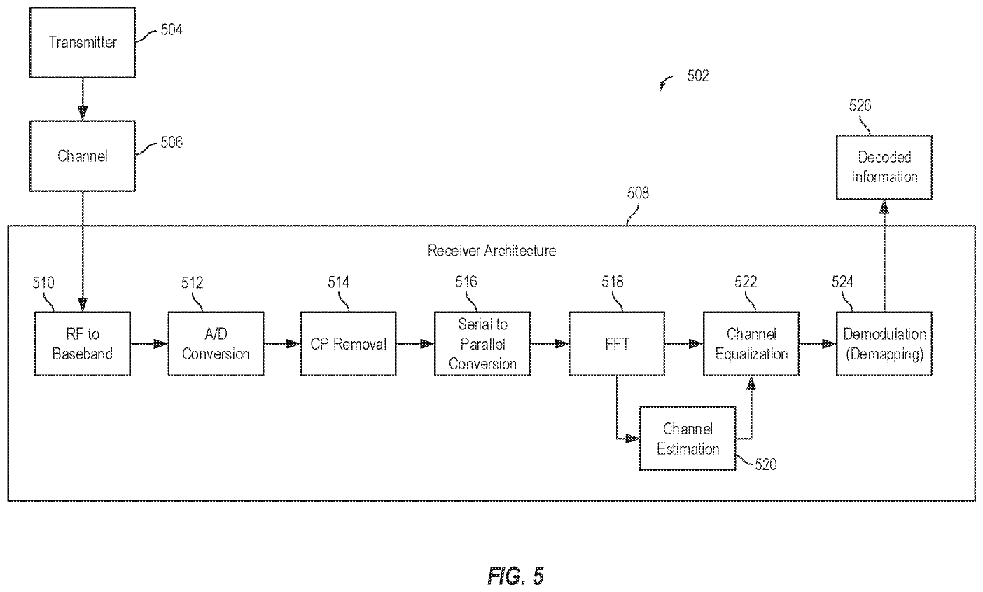

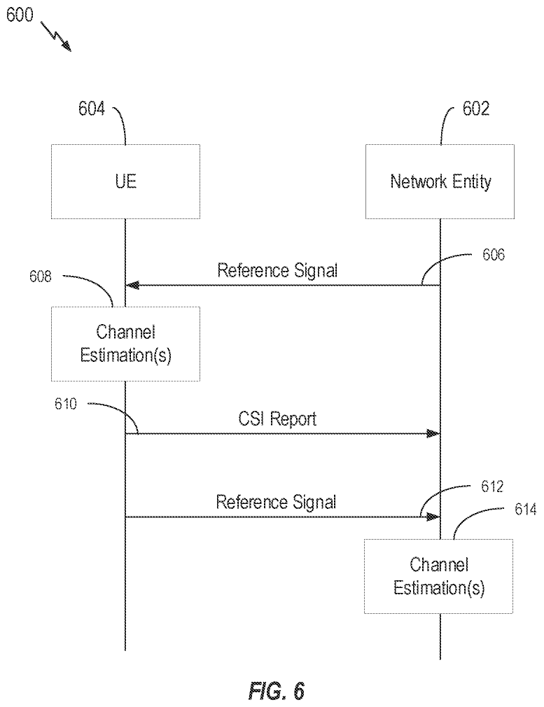

Aspects described herein overcome the aforementioned technical problem(s) by providing techniques for estimating a response of a UE receiver for link adaptation using a digital representation of said receiver. A network entity may predict the performance of the UE receiver decoding a received signal based on the digital representation of the UE receiver and an estimation of a communication channel, which may be determined using measurements of a reference signal received from the UE, for example, as further described herein with respect to FIG. 6. The network entity may obtain, from the UE, an indication of the UE receiver used at the UE for wireless communications, for example, via UE capability information. As an example, the network entity may obtain an indication of an artificial intelligence (AI) model (e.g., neural network coefficients) that simulates one or more signal decoding operations of the UE receiver, such as baseband recovery, channel estimation, channel equalization, and/or demodulation, as further described herein with respect to FIGS. 5 and 8-10. The network entity may determine link adaptation parameters (e.g., a PMI, RI, and/or modulation and coding scheme (MCS)) for the communication link between the network entity and the UE based on the estimated performance of the UE receiver. The network entity may send, to the UE, the link adaptation parameters for the UE to use for communications between the network entity and the UE.

The techniques for communication link adaptation using a digital representation of a UE receiver as described herein may provide any of various beneficial effects and/or advantages. The techniques for communication link adaptation described herein may enable improved wireless communication performance, such as reduced signaling overhead associated with CSF reporting, increased tracking rate for link adaptation, increased throughput, reduced latencies, spectral efficiencies, etc. The improved wireless communication performance may be attributable to the communication link adaptation described herein that allows a network entity to estimate the performance of a UE receiver with reduced CSF reporting or without CSF reporting. The reduced CSF reporting can facilitate such signaling overhead to be used for other communications. The communication link adaptation described herein can track high rate varying channels, for example, due to the network entity being able to estimate the performance of the UE receiver at a rate that matches or exceeds the rate associated with the changing channel conditions. In some cases, the communication link adaptation described herein may facilitate overhead free, high-rate tracking link adaptation.

### Introduction to Wireless Communications Networks

The techniques and methods described herein may be used for various wireless communications networks. While aspects may be described herein using terminology commonly associated with 3G, 4G, 5G, 6G, and/or other generations of wireless technologies, aspects of the present disclosure may likewise be applicable to other communications systems and standards not explicitly mentioned herein.

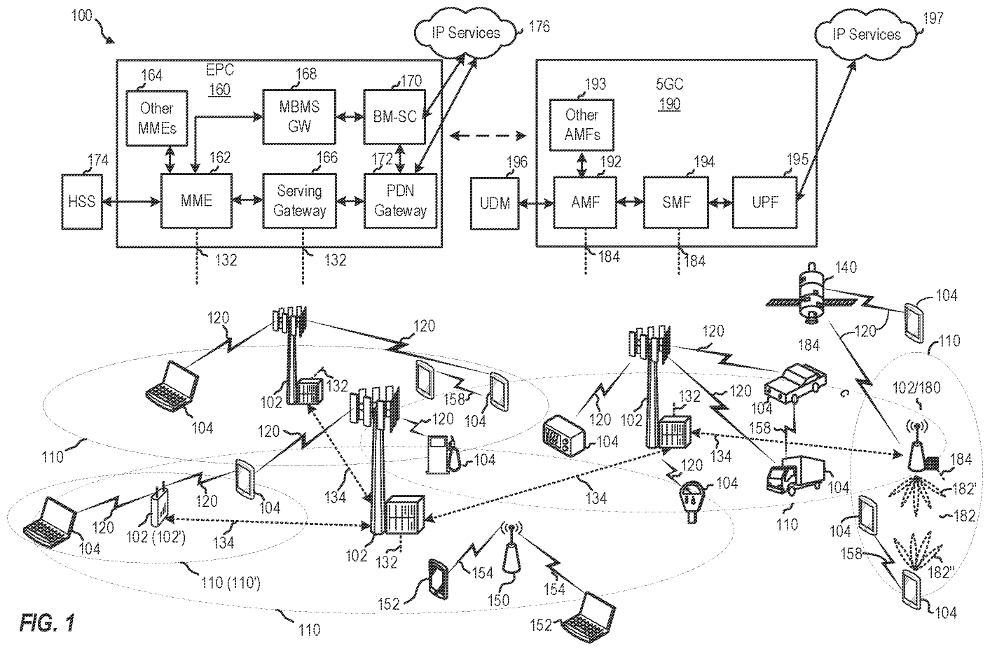

FIG. 1 depicts an example of a wireless communications network 100, in which aspects described herein may be implemented.

Generally, wireless communications network 100 includes various network entities (alternatively, network elements or network nodes). A network entity is generally a communications device and/or a communications function performed by a communications device (e.g., a user equipment (UE), a base station (BS), a component of a BS, a server, etc.). As such communications devices are part of wireless communications network 100, and facilitate wireless communications, such communications devices may be referred to as wireless communications devices. For example, various functions of a network as well as various devices associated with and interacting with a network may be considered network entities. Further, wireless communications network 100 includes terrestrial aspects, such as ground-based network entities (e.g., BSs 102), and non-terrestrial aspects (also referred to herein as non-terrestrial network entities), such as satellite 140 and transporter, which may include network entities on-board (e.g., one or more BSs) capable of communicating with other network elements (e.g., terrestrial BSs) and UEs.

In the depicted example, wireless communications network 100 includes BSs 102, UEs 104, and one or more core networks, such as an Evolved Packet Core (EPC) 160 and 5G Core (5GC) network 190, which interoperate to provide communications services over various communications links, including wired and wireless links.

FIG. 1 depicts various example UEs 104, which may more generally include: a cellular phone, smart phone, session initiation protocol (SIP) phone, laptop, personal digital assistant (PDA), satellite radio, global positioning system, multimedia device, video device, digital audio player, camera, game console, tablet, smart device, wearable device, vehicle, electric meter, gas pump, large or small kitchen appliance, healthcare device, implant, sensor/actuator, display, internet of things (IoT) devices, always on (AON) devices, edge processing devices, data centers, or other similar devices. UEs 104 may also be referred to more generally as a mobile device, a wireless device, a station, a mobile station, a subscriber station, a mobile subscriber station, a mobile unit, a subscriber unit, a wireless unit, a remote unit, a remote device, an access terminal, a mobile terminal, a wireless terminal, a remote terminal, a handset, and others.

BSs 102 wirelessly communicate with (e.g., transmit signals to or receive signals from) UEs 104 via communications links 120. The communications links 120 between BSs 102 and UEs 104 may include uplink (UL) (also referred to as reverse link) transmissions from a UE 104 to a BS 102 and/or downlink (DL) (also referred to as forward link) transmissions from a BS 102 to a UE 104. The communications links 120 may use multiple-input and multiple-output (MIMO) antenna technology, including spatial multiplexing, beamforming, and/or transmit diversity in various aspects.

BSs 102 may generally include: a NodeB, enhanced NodeB (eNB), next generation enhanced NodeB (ng-eNB), next generation NodeB (gNB or gNodeB), access point, base transceiver station, radio base station, radio transceiver, transceiver function, transmission reception point, and/or others. Each of BSs 102 may provide communications coverage for a respective coverage area 110, which may sometimes be referred to as a cell, and which may overlap in some cases (e.g., small cell 102′ may have a coverage area 110′ that overlaps the coverage area 110 of a macro cell). A BS may, for example, provide communications coverage for a macro cell (covering relatively large geographic area), a pico cell (covering relatively smaller geographic area, such as a sports stadium), a femto cell (relatively smaller geographic area (e.g., a home)), and/or other types of cells.

Generally, a cell may refer to a portion, partition, or segment of wireless communication coverage served by a network entity within a wireless communication network. A cell may have geographic characteristics, such as a geographic coverage area, as well as radio frequency characteristics, such as time and/or frequency resources dedicated to the cell. For example, a specific geographic coverage area may be covered by multiple cells employing different frequency resources (e.g., bandwidth parts) and/or different time resources. As another example, a specific geographic coverage area may be covered by a single cell. In some contexts (e.g., a carrier aggregation scenario and/or multi-connectivity scenario), the terms “cell” or “serving cell” may refer to or correspond to a specific carrier frequency (e.g., a component carrier) used for wireless communications, and a “cell group” may refer to or correspond to multiple carriers used for wireless communications. As examples, in a carrier aggregation scenario, a UE may communicate on multiple component carriers corresponding to multiple (serving) cells in the same cell group, and in a multi-connectivity (e.g., dual connectivity) scenario, a UE may communicate on multiple component carriers corresponding to multiple cell groups.

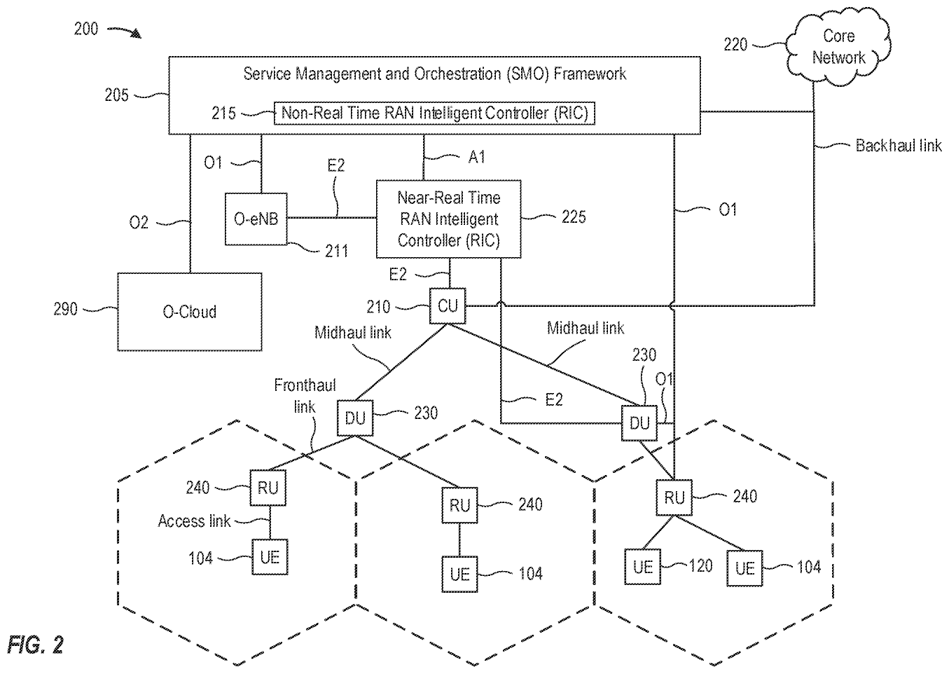

While BSs 102 are depicted in various aspects as unitary communications devices. BSs 102 may be implemented in various configurations. For example, one or more components of a base station may be disaggregated, including a central unit (CU), one or more distributed units (DUs), one or more radio units (RUs), a Near-Real Time (Near-RT) RAN Intelligent Controller (RIC), or a Non-Real Time (Non-RT) RIC, to name a few examples. In another example, various aspects of a base station may be virtualized. More generally, a base station (e.g., BS 102) may include components that are located at a single physical location or components located at various physical locations. In examples in which a base station includes components that are located at various physical locations, the various components may each perform functions such that, collectively, the various components achieve functionality that is similar to a base station that is located at a single physical location. In some aspects, a base station including components that are located at various physical locations may be referred to as a disaggregated radio access network architecture, such as an Open RAN (O-RAN) or Virtualized RAN (VRAN) architecture. FIG. 2 depicts and describes an example disaggregated base station architecture.

Different BSs 102 within wireless communications network 100 may also be configured to support different radio access technologies, such as 3G, 4G, and/or 5G. For example, BSs 102 configured for 4G LTE (collectively referred to as Evolved Universal Mobile Telecommunications System (UMTS) Terrestrial Radio Access Network (E-UTRAN)) may interface with the EPC 160 through first backhaul links 132 (e.g., an SI interface). BSs 102 configured for 5G (e.g., 5G NR or Next Generation RAN (NG-RAN)) may interface with 5GC 190 through second backhaul links 184. BSs 102 may communicate directly or indirectly (e.g., through the EPC 160 or 5GC 190) with each other over third backhaul links 134 (e.g., X2 interface), which may be wired or wireless.

Wireless communications network 100 may subdivide the electromagnetic spectrum into various classes, bands, channels, or other features. In some aspects, the subdivision is provided based on wavelength and frequency, where frequency may also be referred to as a carrier, a subcarrier, a frequency channel, a tone, or a subband. For example, 3GPP currently defines Frequency Range 1 (FR1) as including 410 MHz-7125 MHz, which is often referred to (interchangeably) as “Sub-6 GHz”. Similarly, 3GPP currently defines Frequency Range 2 (FR2) as including 24,250 MHz-71,000 MHz, which is sometimes referred to (interchangeably) as a “millimeter wave” (“mmW” or “mmWave”). In some cases. FR2 may be further defined in terms of sub-ranges, such as a first sub-range FR2-1 including 24,250 MHz-52.600 MHz and a second sub-range FR2-2 including 52,600 MHz-71,000 MHz. A base station configured to communicate using mmWave/near mm Wave radio frequency bands (e g., a mm Wave base station such as BS 180) may utilize beamforming (e.g., 182) with a UE (e.g., 104) to improve path loss and range.

The communications links 120 between BSs 102 and, for example, UEs 104, may be through one or more carriers, which may have different bandwidths (e.g., 5, 10, 15, 20, 100, 400, and/or other MHz), and which may be aggregated in various aspects. Carriers may or may not be adjacent to each other. Allocation of carriers may be asymmetric with respect to DL and UL (e.g., more or fewer carriers may be allocated for DL than for UL).

Communications using higher frequency bands may have higher path loss and a shorter range compared to lower frequency communications. Accordingly, certain base stations (e.g., 180 in FIG. 1) may utilize beamforming 182 with a UE 104 to improve path loss and range. For example, BS 180 and the UE 104 may each include a plurality of antennas, such as antenna elements, antenna panels, and/or antenna arrays to facilitate the beamforming. In some cases, BS 180 may transmit a beamformed signal to UE 104 in one or more transmit directions 182″. UE 104 may receive the beamformed signal from the BS 180 in one or more receive directions 182″. UE 104 may also transmit a beamformed signal to the BS 180 in one or more transmit directions 182″. BS 180 may also receive the beamformed signal from UE 104 in one or more receive directions 182′ BS 180 and UE 104 may then perform beam training to determine the best receive and transmit directions for each of BS 180 and UE 104. Notably, the transmit and receive directions for BS 180 may or may not be the same. Similarly, the transmit and receive directions for UE 104 may or may not be the same.

Wireless communications network 100 further includes a Wi-Fi AP 150 in communication with Wi-Fi stations (STAs) 152 via communications links 154 in, for example, a 2.4 GHz and/or 5 GHz unlicensed frequency spectrum.

Certain UEs 104 may communicate with each other using device-to-device (D2D) communications link 158. D2D communications link 158 may use one or more sidelink channels, such as a physical sidelink broadcast channel (PSBCH), a physical sidelink discovery channel (PSDCH), a physical sidelink shared channel (PSSCH), a physical sidelink control channel (PSCCH), and/or a physical sidelink feedback channel (PSFCH).

EPC 160 may include various functional components, including: a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and/or a Packet Data Network (PDN) Gateway 172, such as in the depicted example, MME 162 may be in communication with a Home Subscriber Server (HSS) 174. MME 162 is the control node that processes the signaling between the UEs 104 and the EPC 160. Generally, MME 162 provides bearer and connection management.

Generally, user Internet protocol (IP) packets are transferred through Serving Gateway 166, which itself is connected to PDN Gateway 172. PDN Gateway 172 provides UE IP address allocation as well as other functions. PDN Gateway 172 and the BM-SC 170 are connected to IP Services 176, which may include, for example, the Internet, an intranet, an IP Multimedia Subsystem (IMS), a Packet Switched (PS) streaming service, and/or other IP services.

BM-SC 170 may provide functions for MBMS user service provisioning and delivery. BM-SC 170 may serve as an entry point for content provider MBMS transmission, may be used to authorize and initiate MBMS Bearer Services within a public land mobile network (PLMN), and/or may be used to schedule MBMS transmissions. MBMS Gateway 168 may be used to distribute MBMS traffic to the BSs 102 belonging to a Multicast Broadcast Single Frequency Network (MBSFN) area broadcasting a particular service, and/or may be responsible for session management (start/stop) and for collecting eMBMS related charging information.

5GC 190 may include various functional components, including: an Access and Mobility Management Function (AMF) 192, other AMFs 193, a Session Management Function (SMF) 194, and a User Plane Function (UPF) 195. AMF 192 may be in communication with Unified Data Management (UDM) 196.

AMF 192 is a control node that processes signaling between UEs 104 and 5GC 190. AMF 192 provides, for example, quality of service (Qos) flow and session management.

Internet protocol (IP) packets are transferred through UPF 195, which is connected to the IP Services 197, and which provides UE IP address allocation as well as other functions for 5GC 190. IP Services 197 may include, for example, the Internet, an intranet, an IMS, a PS streaming service, and/or other IP services.

In various aspects, a network entity or network node can be implemented as an aggregated base station, as a disaggregated base station, a component of a base station, an integrated access and backhaul (IAB) node, a relay node, a sidelink node, to name a few examples.

FIG. 2 depicts an example disaggregated base station 200 architecture. The disaggregated base station 200 architecture may include one or more central units (CUs) 210 that can communicate directly with a core network 220 via a backhaul link, or indirectly with the core network 220 through one or more disaggregated base station units (such as a Near-Real Time (Near-RT) RAN Intelligent Controller (RIC) 225 via an E2 link, or a Non-Real Time (Non-RT) RIC 215 associated with a Service Management and Orchestration (SMO) Framework 205, or both). A CU 210 may communicate with one or more distributed units (DUs) 230 via respective midhaul links, such as an F1 interface. The DUs 230 may communicate with one or more radio units (RUs) 240 via respective fronthaul links. The RUs 240 may communicate with respective UEs 104 via one or more radio frequency (RF) access links. In some implementations, the UE 104 may be simultaneously served by multiple RUs 240.

Each of the units, e.g., the CUS 210, the DUs 230, the RUs 240, as well as the Near-RT RICs 225, the Non-RT RICs 215 and the SMO Framework 205, may include one or more interfaces or be coupled to one or more interfaces configured to receive or transmit signals, data, or information (collectively, signals) via a wired or wireless transmission medium. Each of the units, or an associated processor or controller providing instructions to the communications interfaces of the units, can be configured to communicate with one or more of the other units via the transmission medium. For example, the units can include a wired interface configured to receive or transmit signals over a wired transmission medium to one or more of the other units. Additionally or alternatively, the units can include a wireless interface, which may include a receiver, a transmitter or transceiver (such as a radio frequency (RF) transceiver), configured to receive or transmit signals, or both, over a wireless transmission medium to one or more of the other units.

In some aspects, the CU 210 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 210. The CU 210 may be configured to handle user plane functionality (e.g., Central Unit-User Plane (CU-UP)), control plane functionality (e.g., Central Unit-Control Plane (CU-CP)), or a combination thereof. In some implementations, the CU 210 can be logically split into one or more CU-UP units and one or more CU-CP units. The CU-UP unit can communicate bidirectionally with the CU-CP unit via an interface, such as the E1 interface when implemented in an O-RAN configuration. The CU 210 can be implemented to communicate with the DU 230, as necessary, for network control and signaling.

The DU 230 may correspond to a logical unit that includes one or more base station functions to control the operation of one or more RUs 240. In some aspects, the DU 230 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3rd Generation Partnership Project (3GPP). In some aspects, the DU 230 may further host one or more low PHY layers. Each layer (or module) can be implemented with an interface configured to communicate signals with other layers (and modules) hosted by the DU 230, or with the control functions hosted by the CU 210.

Lower-layer functionality can be implemented by one or more RUs 240. In some deployments, an RU 240, controlled by a DU 230, may correspond to a logical node that hosts RF processing functions, or low-PHY layer functions (such as performing fast Fourier transform (FFT), inverse FFT (IFFT), digital beamforming, physical random access channel (PRACH) extraction and filtering, or the like), or both, based at least in part on the functional split, such as a lower layer functional split. In such an architecture, the RU(s) 240 can be implemented to handle over the air (OTA) communications with one or more UEs 104. In some implementations, real-time and non-real-time aspects of control and user plane communications with the RU(s) 240 can be controlled by the corresponding DU 230. In some scenarios, this configuration can enable the DU(s) 230 and the CU 210 to be implemented in a cloud-based RAN architecture, such as a vRAN architecture.

The SMO Framework 205 may be configured to support RAN deployment and provisioning of non-virtualized and virtualized network elements. For non-virtualized network elements, the SMO Framework 205 may be configured to support the deployment of dedicated physical resources for RAN coverage requirements which may be managed via an operations and maintenance interface (such as an O1 interface). For virtualized network elements, the SMO Framework 205 may be configured to interact with a cloud computing platform (such as an open cloud (O-Cloud) 290) to perform network element life cycle management (such as to instantiate virtualized network elements) via a cloud computing platform interface (such as an O2 interface). Such virtualized network elements can include, but are not limited to, CUs 210. DUs 230, RUs 240 and Near-RT RICs 225. In some implementations, the SMO Framework 205 can communicate with a hardware aspect of a 4G RAN, such as an open eNB (O-eNB) 211, via an O1 interface. Additionally, in some implementations, the SMO Framework 205 can communicate directly with one or more DUs 230 and/or one or more RUs 240 via an O1 interface. The SMO Framework 205 also may include a Non-RT RIC 215 configured to support functionality of the SMO Framework 205.

The Non-RT RIC 215 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 225. The Non-RT RIC 215 may be coupled to or communicate with (such as via an A1 interface) the Near-RT RIC 225. The Near-RT RIC 225 may be configured to include a logical function that enables near-real-time control and optimization of RAN elements and resources via data collection and actions over an interface (such as via an E2 interface) connecting one or more CUs 210, one or more DUs 230, or both, as well as an O-eNB, with the Near-RT RIC 225.

In some implementations, to generate AI/ML models to be deployed in the Near-RT RIC 225, the Non-RT RIC 215 may receive parameters or external enrichment information from external servers. Such information may be utilized by the Near-RT RIC 225 and may be received at the SMO Framework 205 or the Non-RT RIC 215 from non-network data sources or from network functions. In some examples, the Non-RT RIC 215 or the Near-RT RIC 225 may be configured to tune RAN behavior or performance. For example, the Non-RT RIC 215 may monitor long-term trends and patterns for performance and employ AI/ML models to perform corrective actions through the SMO Framework 205 (such as reconfiguration via O1) or via creation of RAN management policies (such as A1 policies).

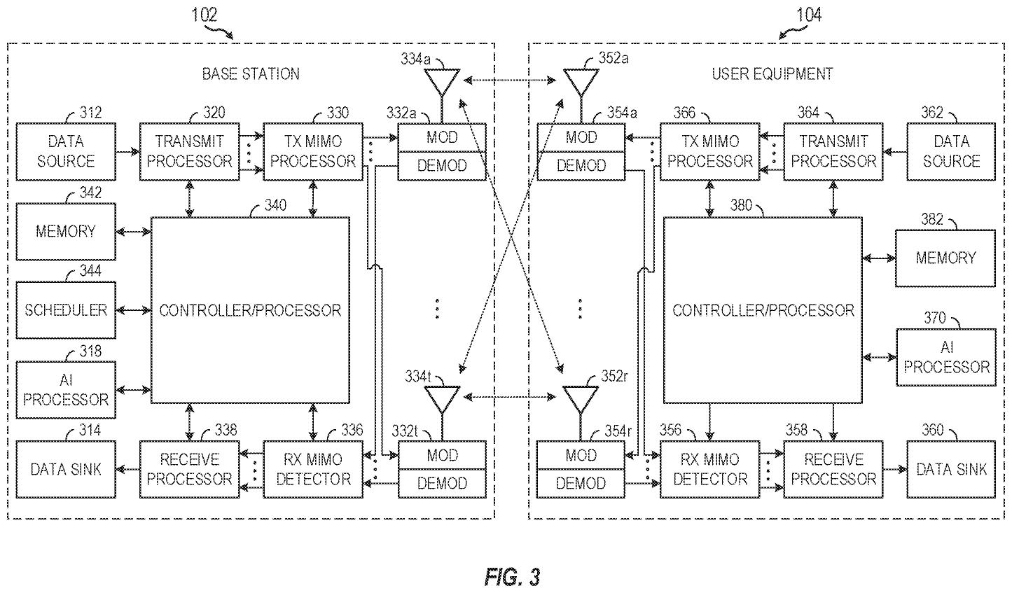

FIG. 3 depicts aspects of an example BS 102 and a UE 104.

Generally, BS 102 includes various processors (e.g., 318, 320, 330, 338, and 340), antennas 334a-t (collectively 334), transceivers 332a-t (collectively 332), which include modulators and demodulators, and other aspects, which enable wireless transmission of data (e.g., data source 312) and wireless reception of data (e.g., data sink 314). For example, BS 102 may send and receive data between BS 102 and UE 104. BS 102 includes controller/processor 340, which may be configured to implement various functions described herein related to wireless communications.

Generally, UE 104 includes various processors (e.g., 358, 364, 366, 370, and 380), antennas 352a-r (collectively 352), transceivers 354a-r (collectively 354), which include modulators and demodulators, and other aspects, which enable wireless transmission of data (e.g., retrieved from data source 362) and wireless reception of data (e.g., provided to data sink 360). UE 104 includes controller/processor 380, which may be configured to implement various functions described herein related to wireless communications.

In regards to an example downlink transmission, BS 102 includes a transmit processor 320 that may receive data from a data source 312 and control information from a controller/processor 340. The control information may be for the physical broadcast channel (PBCH), physical control format indicator channel (PCFICH), physical hybrid automatic repeat request (HARQ) indicator channel (PHICH), physical downlink control channel (PDCCH), group common PDCCH (GC PDCCH), and/or others. The data may be for the physical downlink shared channel (PDSCH), in some examples.

Transmit processor 320 may process (e.g., encode and symbol map) the data and control information to obtain data symbols and control symbols, respectively. Transmit processor 320 may also generate reference symbols, such as for the primary synchronization signal (PSS), secondary synchronization signal (SSS), PBCH demodulation reference signal (DMRS), and channel state information reference signal (CSI-RS).

Transmit (TX) multiple-input multiple-output (MIMO) processor 330 may perform spatial processing (e.g., precoding) on the data symbols, the control symbols, and/or the reference symbols, if applicable, and may provide output symbol streams to the modulators (MODs) in transceivers 332a-332t. Each modulator in transceivers 332a-332t may process a respective output symbol stream to obtain an output sample stream. Each modulator may further process (e.g., convert to analog, amplify, filter, and upconvert) the output sample stream to obtain a downlink signal. Downlink signals from the modulators in transceivers 332a-332t may be transmitted via the antennas 334a-334t, respectively.

In order to receive the downlink transmission, UE 104 includes antennas 352a-352r that may receive the downlink signals from the BS 102 and may provide received signals to the demodulators (DEMODs) in transceivers 354a-354r, respectively. Each demodulator in transceivers 354a-354r may condition (e.g., filter, amplify, downconvert, and digitize) a respective received signal to obtain input samples. Each demodulator may further process the input samples to obtain received symbols.

RX MIMO detector 356 may obtain received symbols from all the demodulators in transceivers 354a-354r, perform MIMO detection on the received symbols if applicable, and provide detected symbols. Receive processor 358 may process (e.g., demodulate, deinterleave, and decode) the detected symbols, provide decoded data for the UE 104 to a data sink 360, and provide decoded control information to a controller/processor 380.

In regards to an example uplink transmission. UE 104 further includes a transmit processor 364 that may receive and process data (e.g., for the PUSCH) from a data source 362 and control information (e.g., for the physical uplink control channel (PUCCH)) from the controller/processor 380. Transmit processor 364 may also generate reference symbols for a reference signal (e.g., for the sounding reference signal (SRS)). The symbols from the transmit processor 364 may be precoded by a TX MIMO processor 366 if applicable, further processed by the modulators in transceivers 354a-354r (e.g., for SC-FDM), and transmitted to BS 102.

At BS 102, the uplink signals from UE 104 may be received by antennas 334a-t, processed by the demodulators in transceivers 332a-332t, detected by a RX MIMO detector 336 if applicable, and further processed by a receive processor 338 to obtain decoded data and control information sent by UE 104. Receive processor 338 may provide the decoded data to a data sink 314 and the decoded control information to the controller/processor 340.

Memories 342 and 382 may store data and program codes for BS 102 and UE 104, respectively.

Scheduler 344 may schedule UEs for data transmission on the downlink and/or uplink.

In various aspects, BS 102 may be described as transmitting and receiving various types of data associated with the methods described herein. In these contexts, “transmitting” may refer to various mechanisms of outputting data, such as outputting data from data source 312, scheduler 344, memory 342, transmit processor 320, controller/processor 340, TX MIMO processor 330, transceivers 332a-t, antenna 334a-t, and/or other aspects described herein. Similarly, “receiving” may refer to various mechanisms of obtaining data, such as obtaining data from antennas 334a-t, transceivers 332a-t. RX MIMO detector 336, controller/processor 340, receive processor 338, scheduler 344, memory 342, and/or other aspects described herein.

In various aspects, UE 104 may likewise be described as transmitting and receiving various types of data associated with the methods described herein. In these contexts, “transmitting” may refer to various mechanisms of outputting data such as outputting data from data source 362, memory 382, transmit processor 364, controller/processor 380, TX MIMO processor 366, transceivers 354a-t, antenna 352a-t, and/or other aspects described herein. Similarly, “receiving” may refer to various mechanisms of obtaining data, such as obtaining data from antennas 352a-t, transceivers 354a-t, RX MIMO detector 356, controller/processor 380, receive processor 358, memory 382, and/or other aspects described herein.

In some aspects, a processor may be configured to perform various operations, such as those associated with the methods described herein, and transmit (output) to or receive (obtain) data from another interface that is configured to transmit or receive, respectively, the data.

In various aspects, artificial intelligence (AI) processors 318 and 370 may perform AI processing for BS 102 and/or UE 104, respectively. The AI processor 318 may include AI accelerator hardware or circuitry such as one or more neural processing units (NPUs), one or more neural network processors, one or more tensor processors, one or more deep learning processors, etc. The AI processor 370 may likewise include AI accelerator hardware or circuitry. As an example, the AI processor 370 may perform AI-based beam management, AI-based channel state feedback (CSF). AI-based antenna tuning, and/or AI-based positioning (e.g., global navigation satellite system (GNSS) positioning). In some cases, the AI processor 318 may process feedback from the UE 104 (e.g., CSF) using hardware accelerated AI inferences and/or AI training. The AI processor 318 may decode compressed CSF from the UE 104, for example, using a hardware accelerated AI inference associated with the CSF. In certain cases, the AI processor 318 may perform certain RAN-based functions including, for example, network planning, network performance management, energy-efficient network operations, etc.

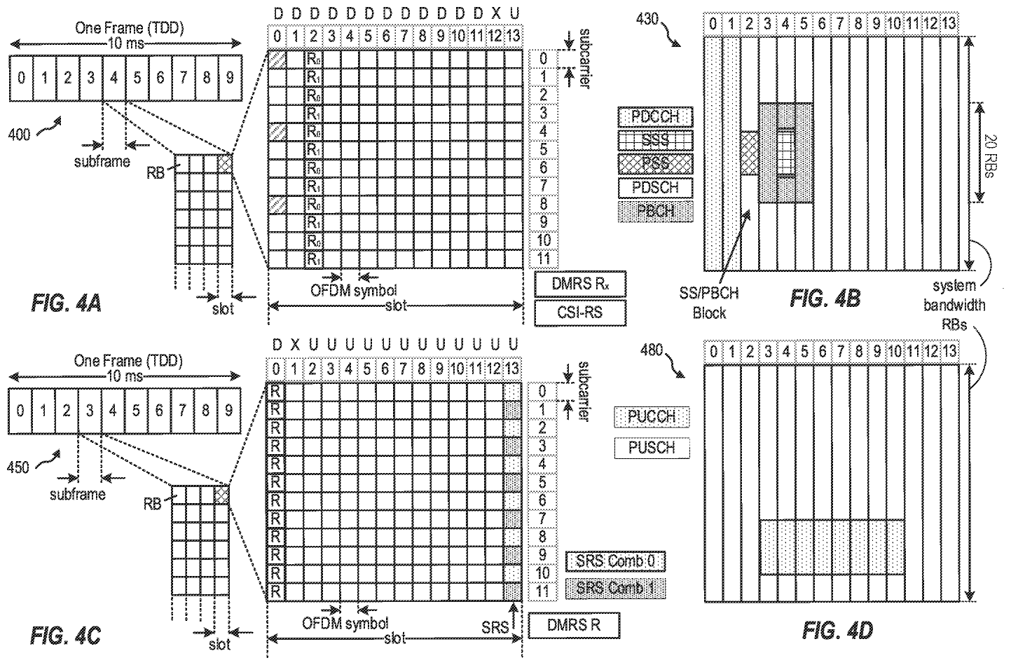

FIGS. 4A, 4B, 4C, and 4D depict aspects of data structures for a wireless communications network, such as wireless communications network 100 of FIG. 1.

In particular, FIG. 4A is a diagram 400 illustrating an example of a first subframe within a 5G (e.g., 5G NR) frame structure, FIG. 4B is a diagram 430 illustrating an example of DL channels within a 5G subframe, FIG. 4C is a diagram 450 illustrating an example of a second subframe within a 5G frame structure, and FIG. 4D is a diagram 480 illustrating an example of UL channels within a 5G subframe.

Wireless communications systems may utilize orthogonal frequency division multiplexing (OFDM) with a cyclic prefix (CP) on the uplink and downlink. Such systems may also support half-duplex operation using time division duplexing (TDD). OFDM and single-carrier frequency division multiplexing (SC-FDM) partition the system bandwidth (e.g., as depicted in FIGS. 4B and 4D) into multiple orthogonal subcarriers. Each subcarrier may be modulated with data. Modulation symbols may be sent in the frequency domain with OFDM and/or in the time domain with SC-FDM

A wireless communications frame structure may be frequency division duplex (FDD), in which, for a particular set of subcarriers, subframes within the set of subcarriers are dedicated for either DL or UL. Wireless communications frame structures may also be time division duplex (TDD), in which, for a particular set of subcarriers, subframes within the set of subcarriers are dedicated for both DL and UL.

In FIGS. 4A and 4C, the wireless communications frame structure is TDD where Dis DL, U is UL, and X is flexible for use between DL/UL. UEs may be configured with a slot format through a received slot format indicator (SFI) (dynamically through DL control information (DCI), or semi-statically/statically through radio resource control (RRC) signaling). In the depicted examples, a 10 ms frame is divided into 10 equally sized 1 ms subframes. Each subframe may include one or more time slots. In some examples, each slot may include 12 or 14 symbols, depending on the cyclic prefix (CP) type (e.g., 12 symbols per slot for an extended CP or 14 symbols per slot for a normal CP). Subframes may also include mini-slots, which generally have fewer symbols than an entire slot. Other wireless communications technologies may have a different frame structure and/or different channels.

In certain aspects, the number of slots within a subframe (e.g., a slot duration in a subframe) is based on a numerology, which may define a frequency domain subcarrier spacing and symbol duration as further described herein. In certain aspects, given a numerology μ, there are 2^{μ} slots per subframe. Thus, numerologies (μ) 0 to 6 may allow for 1, 2, 4, 8, 16, 32, and 64 slots, respectively, per subframe. In some cases, the extended CP (e.g., 12 symbols per slot) may be used with a specific numerology. e.g., numerology 2 allowing for 4 slots per subframe. The subcarrier spacing and symbol length/duration are a function of the numerology. The subcarrier spacing may be equal to 2^{μ}×15 kHz, where u is the numerology 0 to 6. As an example, the numerology μ=0 corresponds to a subcarrier spacing of 15 KHz, and the numerology μ=6 corresponds to a subcarrier spacing of 960 KHz. The symbol length/duration is inversely related to the subcarrier spacing. FIGS. 4A, 4B, 4C, and 4D provide an example of a slot format having 14 symbols per slot (e.g., a normal CP) and a numerology μ=2 with 4 slots per subframe. In such a case, the slot duration is 0.25 ms, the subcarrier spacing is 60 kHz, and the symbol duration is approximately 16.67 μs.

As depicted in FIGS. 4A, 4B, 4C, and 4D, a resource grid may be used to represent the frame structure. Each time slot includes a resource block (RB) (also referred to as physical RBs (PRBs)) that extends, for example, 12 consecutive subcarriers. The resource grid is divided into multiple resource elements (REs). The number of bits carried by each RE depends on the modulation scheme including, for example, quadrature phase shift keying (QPSK) or quadrature amplitude modulation (QAM).

As illustrated in FIG. 4A, some of the REs carry reference (pilot) signals (RS) for a UE (e.g., UE 104 of FIGS. 1 and 3). The RS may include demodulation RS (DMRS) and/or channel state information reference signals (CSI-RS) for channel estimation at the UE. The RS may also include beam measurement RS (BRS), beam refinement RS (BRRS), and/or phase tracking RS (PT-RS).

FIG. 4B illustrates an example of various DL channels within a subframe of a frame. The physical downlink control channel (PDCCH) carries DCI within one or more control channel elements (CCEs), each CCE including, for example, nine RE groups (REGs), each REG including, for example, four consecutive REs in an OFDM symbol.

A primary synchronization signal (PSS) may be within symbol 2 of particular subframes of a frame. The PSS is used by a UE (e.g., 104 of FIGS. 1 and 3) to determine subframe/symbol timing and a physical layer identity.

A secondary synchronization signal (SSS) may be within symbol 4 of particular subframes of a frame. The SSS is used by a UE to determine a physical layer cell identity group number and radio frame timing.

Based on the physical layer identity and the physical layer cell identity group number, the UE can determine a physical cell identifier (PCI). Based on the PCI, the UE can determine the locations of the aforementioned DMRS. The physical broadcast channel (PBCH), which carries a master information block (MIB), may be logically grouped with the PSS and SSS to form a synchronization signal (SS)/PBCH block. The MIB provides a number of RBs in the system bandwidth and a system frame number (SFN). The physical downlink shared channel (PDSCH) carries user data, broadcast system information not transmitted through the PBCH such as system information blocks (SIBs), and/or paging messages.

As illustrated in FIG. 4C, some of the REs carry DMRS (indicated as R for one particular configuration, but other DMRS configurations are possible) for channel estimation at the base station. The UE may transmit DMRS for the PUCCH and DMRS for the PUSCH. The PUSCH DMRS may be transmitted, for example, in the first one or two symbols of the PUSCH. The PUCCH DMRS may be transmitted in different configurations depending on whether short or long PUCCHs are transmitted and depending on the particular PUCCH format used. UE 104 may transmit sounding reference signals (SRS). The SRS may be transmitted, for example, in the last symbol of a subframe. The SRS may have a comb structure, and a UE may transmit SRS on one of the combs. The SRS may be used by a base station for channel quality estimation to enable frequency-dependent scheduling on the UL.

FIG. 4D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and HARQ ACK/NACK feedback. The PUSCH carries data, and may additionally be used to carry a buffer status report (BSR), a power headroom report (PHR), and/or UCI.

### Example Receiver Architecture

Certain wireless communication systems may be implemented using orthogonal frequency division multiplexing (OFDM). The fundamental concept of a multicarrier system (such as OFDM) is the division of a data stream into several narrow subcarriers. An OFDM signal is essentially a bundle of narrowband carriers (e.g., subcarriers) transmitted across a carrier bandwidth. Each of the subcarriers conveys information by modulating the phase and/or the amplitude of the subcarrier over a particular symbol duration. For example, each subcarrier may use either phase-shift-keying (PSK) or quadrature-amplitude-modulation (QAM) to convey information.

FIG. 5 is a diagram illustrating an example receiver 502 in communication with a transmitter 504 over a communication channel 506. In this example, the transmitter 504 transmits a signal (e.g., an OFDM signal) on the communication channel 506, for example, a wireless communication channel between the transmitter 504 and the receiver 502. The signal is encoded to convey information, for example, using a modulation scheme, such as PSK or QAM. The receiver 502 receives the signal as affected by the channel 506, for example, due to various signal propagation effects including path loss, multipath effects, fading, Doppler effects, etc.

The receiver 502 may decode the received signal using a receiver architecture 508 that outputs decoded information 526. In this example, the receiver architecture 508 processes the received signal through various RF circuitry and digital signal processing operations. In certain aspects, the receiver 502 may include the transceivers 354, antenna(s) 352, RX MIMO processor 356, receive processor 358. AI processor 370, and/or controller/processor 380 of the UE 104 illustrated in FIG. 3. At block 510, the receiver may amplify the received RF signal and downconvert that amplified signal to recover a baseband signal, for example, using one or more mixers and a basedband filter. The RF carrier signal to baseband signal recovery may be implemented using an RF front-end or RF receiver circuitry.

At block 512, the baseband signal is digitally sampled, for example, using an analog-to-digital converter (ADC). The baseband signal is converted from an analog signal to a digital signal for demodulation.

At block 514, a cyclic prefix (CP) is removed from symbols of the signal. The CP provides a guard period to help prevent inter-symbol interference, which may be caused by a propagation channel delay spread, for example.

At block 516, the serial stream of symbols may be converted to N parallel streams of symbols.

At block 518, the N parallel stream of symbols may be transformed to the frequency domain, for example, using a Fast Fourier Transform (FFT). The FFT may include any of various types of FFTs, for example, a radix-2 FFT, a radix-4 FFT, a mixed-radix FFT.

At block 520, a channel estimation is performed to determine various signal propagation effects of the channel 506 associated with the subcarriers of the OFDM signal. The channel estimation may include any of various types of channel estimations, for example, a frequency domain minimum mean square error (MMSE) or a time domain MMSE. As an example, the received signal may include pilot values at certain pilot subcarriers (e.g., DMRS) and information modulated in certain data subcarriers. The pilot values and respective position in the frequency domain (e.g., the pilot carrier index) are known to the receiver 502, and with this information, the receiver 502 can estimate the signal propagation effects of the channel 506 on the pilot subcarriers. Hence, the receiver may estimate (e.g., interpolate) the channel values between the pilot subcarriers and the data subcarriers to determine an estimate of signal propagation effects for the data subcarriers.

At block 522, channel equalization is performed to compensate for the signal propagation effects of the channel 506 using the channel estimation determined at block 520. The channel equalization may include any of various types of channel equalization, for example, MMSE, blind equalization, adaptive median filter, etc. As an example, noise and/or interference as determined from the channel estimation may be filtered from the data subcarriers. In some cases, the channel equalization may compensate for other effects, such as propagation delay, fading, multipath effects, Doppler effects, etc.

At block 524, for each of equalized symbol streams, the phase and amplitude may be represented as a constellation point. The constellation points of the symbol streams may form constellation of complex values representative of a codeword (e.g., a combination of one or more bits). The constellation points are demapped (demodulated or decoded) to transform the constellation points into the codeword or decoded information 526. As the subcarriers are subjected to various signal propagation effects through the channel 506, the constellation points may have errors (e.g., phase and/or magnitude errors) in the position of the constellation points. The receiver may perform any of various decoding operations to estimate the data conveyed in the constellation points, such as hard decision decoding (demodulation) or soft decision decoding (demodulation).

As an example, each received constellation point may be compared to a reference constellation point (for example, using an MMSE-based demodulator or a maximum likelihood-based demodulator). The receiver may determine the reference constellation point that is closest to the received point, and the codeword that belongs to the closest reference constellation point may be assigned to the received point. The decoded information may include the one or more codewords decoded among the constellation points for the symbol streams. The information that is encoded at the transmitter and successfully decoded at the receiver may be called mutual information, which may be indicative of the capacity of the channel 506, for example, the data rate or throughput rate. The various types of decoding operations (e.g., a specific type of FFT, channel estimation, channel equalization, and/or demodulation) may be selected based on the performance of the corresponding operation, such as latency (e.g., computation time), memory usage, number of computations performed, etc.

### Aspects Related to Channel State Feedback

In certain wireless communication systems, closed-loop feedback associated with a communication channel may be used to dynamically adapt to channel conditions that may change over time, for example, due to changes with respect to UE mobility, weather conditions, interference, or noise. In some cases, a UE may receive a reference signal (e.g., synchronization signal block (SSB), CSI-RS, DMRS, etc.) from a network entity (or another UE) and report channel state feedback to the network entity (or the other UE), where the channel state feedback is determined based on measurements of the reference signal received at the UE. In certain cases, a UE may transmit a reference signal (e.g., SSB, CSI-RS, DMRS, PT-RS, SRS, etc.), and a network entity (or another UE) may determine characteristics associated with the channel based on measurements of the received reference signal.

FIG. 6 depicts a process flow 600 for closed-loop feedback associated with a communication channel in a network between a network entity 602 and a UE 604.

At 606, the UE 604 receives a reference signal (e.g., SSB, CSI-RS, etc.) from the network entity 602.

At 608, the UE 604 performs channel calculations based on the reference signal, such as determining a channel estimate H based on the received reference signal. For example, the UE 604 may include a demodulator, which may be part of a transceiver (e.g., transceiver 354 of FIG. 3), RX MIMO detector (e.g., RX MIMO detector 356 of FIG. 3), and/or receive processor (e.g., receive processor 358 of FIG. 3) of UE 604. The demodulator, such as a component of the demodulator, may take as input the reference signal as received over multiple antennas of the UE 604 and output a vector \vec{y} that is a representation of the received reference signal as received over each of the multiple antennas of the UE 604.

Based on a received signal model, the vector \vec{y} can be represented as follows in equation (1):

$$\vec{y} = H \vec{x} + \vec{n} \qquad ( 1 )$$

In equation (1), H corresponds to a matrix representation of the communications channel, as in a channel estimate of the communications channel the signal is communicated in (e.g., downlink communication channel where the reference signal is communicated), \vec{x} is the vector representing symbols transmitted by network entity 602 over a number of spatial layers, and \vec{n} is thermal noise across the communications channel. In certain aspects. H has a size equal to the number of antennas used to receive the signaling, Nₐₙₜ, times the number of spatial layers. N₁, (e.g., the number of beamformed transmissions, number of antenna ports, etc.). For example, H has a number of rows equal to Nₐₙₜ and a number of columns equal to N₁. In certain aspects, the symbols that form the reference signal are known by the UE 604 (e.g., configured or preconfigured at the UE). UE 604 can determine the channel estimate H based on receiving the reference signal.

In certain aspects, UE 604 may further calculate, as part of the channel calculations, a precoder (e.g., precoder matrix) V based on the channel estimate H. For example, UE 604 may be configured to perform singular value decomposition (SVD) based precoding to determine the precoder V. For example, SVD(H)=[U S V], such that SVD provides the precoder V. U may be related to the ordering of the rows of H, as in the ordering of the antennas as represented by H. It should be understood that other suitable techniques may be used to determine the precoder V based on the channel estimate H.

At 610, UE 604 sends to network entity 602 a CSI report indicating the determined channel estimate H and/or precoder V. For example, the UE may determine one or more CSI parameters, such as channel quality indicator (CQI), precoding matrix indicator (PMI), and/or rank indicator (RI) based on H and/or V. RI may represent the number of MIMO layers requested by the UE for downlink transmissions. PMI may define a set of indices corresponding to one or more precoding matrices (e.g., the precoding matrix V) to apply to downlink transmissions. In certain aspects, the PMI may indicate the UE's preferred precoding for the downlink transmissions on the PDSCH. CQI may be an indicator of channel quality, such as corresponding to H. The UE 604 may send an indication of the one or more determined CSI parameters to the network entity 602 in the CSI report. The network entity 602 may schedule downlink data transmissions to the UE 604 accordingly, such as using a modulation scheme, code rate, number of transmission layers, etc., that the network entity determines based on the CSI report.

At 612. UE 604 sends a reference signal (e.g., SSB. CSI-RS, DM-RS, PT-RS, SRS, etc.) to the network entity 602.

At 614, the network entity 602 performs channel calculations based on the reference signal, such as determining a channel estimate H based on the received reference signal, for example, as described herein with respect to the UE performing channel calculations at 608.

In certain aspects, network entity 602 may further calculate, as part of the channel calculations, a precoder (e.g., precoder matrix) V based on the channel estimate H, for example, as described herein with respect to the UE 604 performing such a calculation. Accordingly, the network entity 602 may determine H and/or V for an uplink channel between UE 604 and network entity 602 based on SRS. Further, as discussed, the uplink channel between UE 604 and network entity 602 may have reciprocity with a downlink channel between UE 604 and network entity 602. Accordingly, the determined values of H and/or V for the uplink channel between UE 604 and network entity 602 may be used for the downlink channel between UE 604 and network entity 602. In some cases, the reciprocity between the uplink channel and the downlink channel may be based on a known difference between the uplink channel and the downlink channel, such that the difference can be represented by a function. Accordingly, in certain aspects, to determine H and/or V for the downlink channel, the network entity 602 may apply a function to H and/or V determined for the uplink channel.

### Example Artificial Intelligence for Wireless Communications

Certain aspects and techniques as described herein may be implemented, at least in part, using some form of artificial intelligence (AI) inference, e.g., the process of using a machine learning (ML) model to infer or predict output data from input data. An example ML model may include a mathematical representation of one or more relationships among various objects to provide an output representing one or more decisions or inferences. Once an ML model has been trained, the ML model may be deployed to process data that may be similar to, or associated with, all or part of the training data and provide an output representing one or more decisions or inferences based on the input data. Some example types of ML models and technologies include artificial neural networks (ANNs), regression analysis (such as statistical models), decision tree learning (such as predictive models), support vector machines (SVMs), large language models (LLMs), generative models, deep learning reinforcement models, probabilistic graphical models (such as a Bayesian network), etc.

ML models may be deployed in one or more devices (e.g., base station(s) and/or user equipment(s)) to support various wired and/or wireless communication aspects of a communication system. For example, an ML model may be trained to identify patterns/relationships in data corresponding to a network, a device, an air interface, or the like. An ML model may support operational decisions relating to one or more aspects, such as channel state determinations, device positioning, transceiver tuning, beamforming, signal coding/decoding, network routing, energy conservation, etc. associated with communications devices (e.g., a UE and/or network entity), services (e.g., as ultra-reliable low latency (URLLC), mobile broadband, and/or Internet of Things (IoT) communications), or networks.

The description herein illustrates, by way of some examples, how one or more tasks/problems may benefit from the application of an ANN, as a type of ML model. It should be understood, however, that other type(s) of ML models may be used in addition to or instead of an ANN. Hence, unless expressly recited, subject matter regarding an ML model is not necessarily intended to be limited to just an ANN solution. Further, it should be understood that, unless otherwise specifically stated, terms such “AI model,” “ML model,” “AI/ML model.” “trained ML model,” or the like are intended to be interchangeable.

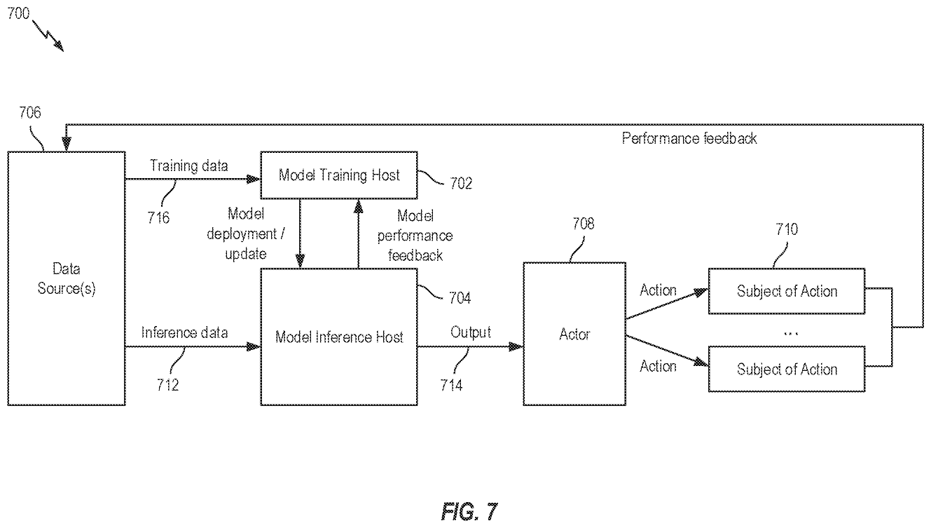

FIG. 7 is a diagram illustrating an example AI architecture 700 that may be used for AI-enhanced wireless communications. As illustrated, the architecture 700 includes multiple logical entities, such as a model training host 702, a model inference host 704, data source(s) 706, and an actor 708. The AI architecture may be used in any of various use cases for wireless communications, such as channel state feedback, beam management, transceiver tuning, energy saving, load balancing, mobility management, and/or coverage optimization, among some examples. As further described herein, the AI architecture may predict a response of a UE receiver to facilitate reduced or overhead free, high rate tracking of a communication link between a UE and a network entity.

The model inference host 704, in the architecture 700, is configured to run an ML model based on inference data 712 provided by data source(s) 706. The model inference host 704 may produce an output 714 (e.g., a prediction) based on the inference data 712, that is then provided as input into the actor 708.

The actor 708 may be an element or an entity of a wireless communication system including, for example, a radio access network (RAN), a wireless local area network, a device-to-device (D2D) communications system, etc. As an example, the actor 708 may be a user equipment (e.g., UE 104 in FIG. 1), a base station (e.g., the BS 102 in FIG. 1 or any disaggregated network entity thereof including a centralized unit (CU), a distributed unit (DU), and/or a radio unit (RU)), an access point, a wireless station, a RAN intelligent controller (RIC) in a cloud-based RAN, among some examples. Additionally, the type of actor 708 may also depend on the type of tasks performed by the model inference host 704, the type of inference data 712 provided to model inference host 704, and/or the type of output 714 produced by model inference host 704.

For example, if output 714 from the model inference host 704 is associated with beam management, the actor 708 may be or include a UE, a DU, or an RU. As another example, if output 714 from model inference host 704 is associated with transmission and/or reception scheduling, the actor 708 may be a CU or a DU.

After the actor 708 receives output 714 from the model inference host 704, actor 708 may determine whether to act based on the output. For example, if actor 708 is a DU or an RU and the output from model inference host 704 is associated with link adaptation as further described herein, the actor 708 may determine whether to change/modify certain link adaptation parameter(s) based on the output 714. If the actor 708 determines to act based on the output 714, actor 708 may indicate the action to at least one subject of the action 710. For example, if the actor 708 determines to change/modify the number of MIMO layers for a communication between the actor 708 and the subject of action 710 (e.g., a UE), the actor 708 may send an indication to change/modify the number of MIMO layers to the subject of action 710 (e.g., a UE).

The data sources 706 may be configured for collecting data that is used as training data 716 for training an ML model, or as inference data 712 for feeding an ML model inference operation. In particular, the data sources 706 may collect data from any of various entities (e.g., the UE and/or the BS), which may include the subject of action 710, and provide the collected data to a model training host 702 for ML model training. For example, after a subject of action 710 (e.g., a UE) receives updated link adaptation parameters (e.g., MIMO and/or beamforming parameters) from actor 708, the subject of action 710 may provide performance feedback associated with the link adaptation parameters to the data sources 706, where the performance feedback may be used by the model training host 702 for monitoring and/or evaluating the ML model performance, such as whether the output 714, provided to actor 708, is accurate. The performance feedback may include CSF, a data error rate, an indication of whether a reception was successfully decoded at the UE, etc., as further described herein. In some examples, if the output 714 provided to actor 708 is inaccurate (or the accuracy is below an accuracy threshold), the model training host 702 may determine to modify or retrain the ML model used by model inference host 704, such as via an ML model deployment/update.

In certain aspects, the model training host 702 may be deployed at or on the same or different entity in which the model inference host 704 is deployed. For example, in order to offload model training processing, which can impact the performance of the model inference host 704, the model training host 702 may be deployed at a model server.

In some aspects, an ML model is deployed at or on a network entity (e.g., such as BS 102 in FIG. 1) for communication channel adaptation. More specifically, a model interference host, such as model inference host 704 in FIG. 7, may be deployed at or on the network entity for simulating a response of a UE receiver as further described herein.

### Aspects Related to Digital Representation of User Equipment Receiver for Communication Channel Adaptation

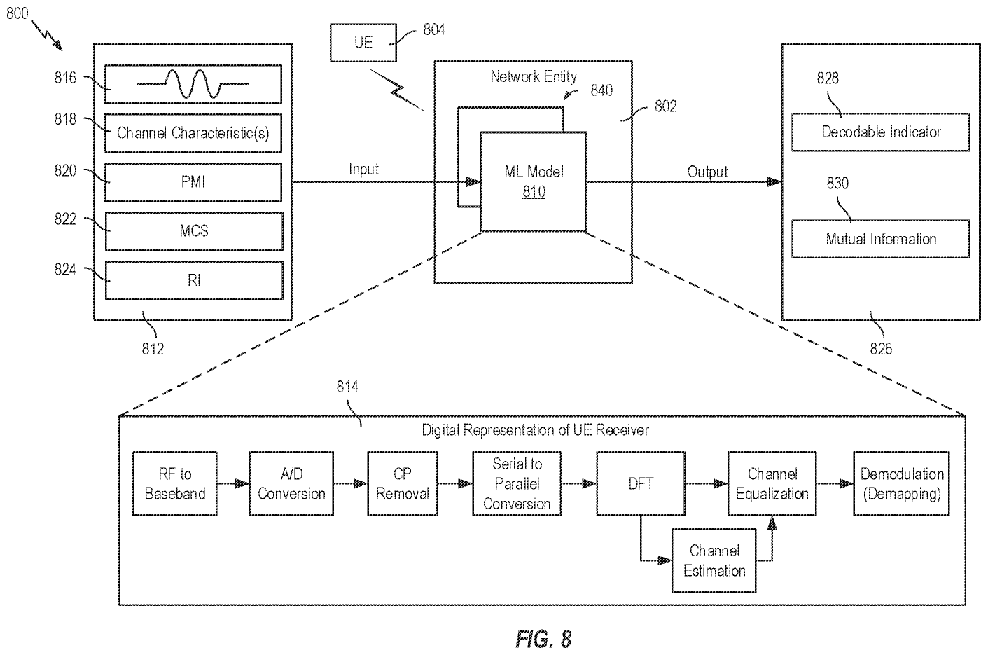

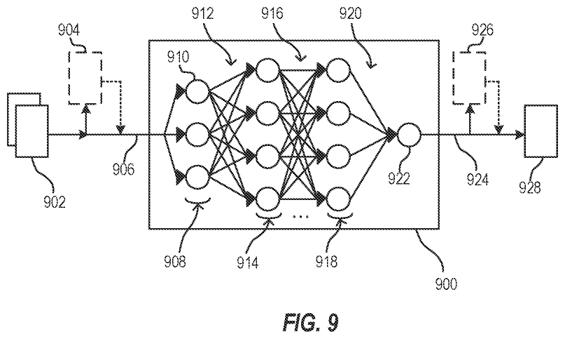

Aspects of the present disclosure provide techniques for estimating a response of a UE receiver for link adaptation using a digital representation of said receiver. In some cases, the digital representation of the UE receiver may include an ML model that simulates or predicts the response of the UE receiver, for example, as further described herein with respect to FIGS. 8 and 9. A network entity may obtain an indication of the ML model in terms of one or more characteristics associated with the ML model.

In certain aspects, the characteristics may facilitate the retrieval of the ML model, for example, from a model repository that stores multiple ML models (e.g., via the model training host 702). In some cases, the characteristics may include an identifier that identifies the ML model, and the identifier may allow the network entity to access the ML model associated with the identifier from a model repository, such as the model training host 702. In certain cases, the network entity may request and/or obtain the ML model from the UE via the identifier.

In certain aspects, the characteristics may facilitate reproduction of the ML model via training and/or configuration. The characteristics may include training data used to train the ML model, for example, as described herein with respect to FIG. 7. The characteristics may include coefficients and/or weights used to configure the ML model (e.g., an ANN). The characteristics may include an indication of the architecture or structure of the ML model, such as the connections of artificial neurons in an ANN and/or the number of layers of artificial neurons employed in the ANN. In some cases, the characteristics may include performance indicators or metrics associated with the ML model, such as an expected or specified accuracy and/or latency of the ML mode.

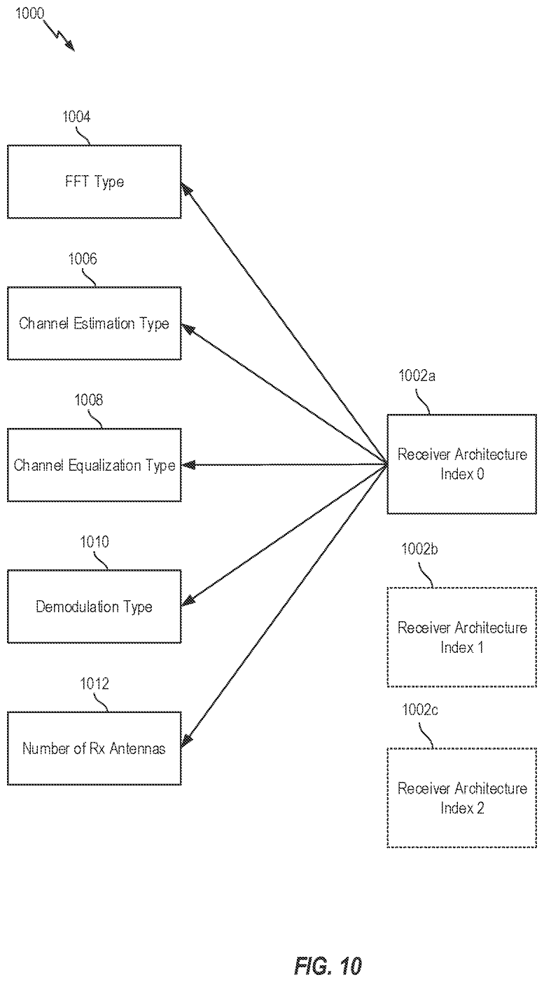

In certain aspects, the network entity may obtain information explicitly describing the architecture of the UE receiver, for example, as further described herein with respect to FIG. 10. The information may indicate the number of receive antennas employed at the UE. The information may identify specific decoding operations employed at the UE, such as a channel estimation type and/or a demodulator type, as further described herein with respect to FIG. 10. In some cases, the network entity may use the information to train, select, or configure a ML model for predicting the response of the UE receiver. For example, based on the information, the network entity may select a ML model that is trained to simulate the receiver architecture corresponding to the UE receiver as indicated by the information. In certain cases, the network entity may use the information to replicate the decoding operations in a simulation that estimates the response of the UE receiver. In some cases, the network entity may perform other modeling techniques without ML to estimate the performance of the UE receiver. For example, in a simulation (without ML), the network entity may perform the specific decoding operations (e.g., the specific channel estimation and/or demodulation) as indicated by the information.

### Example Machine Learning UE Receiver Response Prediction

FIG. 8 is a diagram illustrating an example of UE receiver response prediction 800 by a network entity 802. In this example, the network entity 802 may be in communication with a UE 804 via a communication channel, for example, as described herein with respect to FIGS. 1-3 and 6. An ML model 810 is deployed at or on the network entity 802 to enable the network entity 802 to estimate a response of a UE receiver (e.g., the receiver 502 of FIG. 5) based on data input to the ML model 810. In some cases, the ML model 810 may be deployed at or on any disaggregated entity associated with a network entity including, for example, a CU. DU. RU, Non-RT RIC. Near-RT RIC, etc.

In certain aspects, the ML model 810 may be trained to simulate or predict a response of a UE receiver based on certain input, as further described herein. In certain cases, the ML model 810 may include an ANN (for example, as further described herein with respect to FIG. 9), regression analysis, decision tree learning, SVM, generative model, a deep learning reinforcement model, etc. The ML model 810 may be an example of a digital representation of a UE receiver 814 (e.g., a virtual receiver of the UE 804) that simulates one or more operations of a receiver, for example, as described herein with respect to FIG. 5. The ML model 810 may be trained to predict the response of certain operations used at the UE receiver 814 to decode received signals, such as specific operations for FFT, channel estimation, channel equalization, and/or demodulation.

In certain aspects, the network entity 802 may have access to multiple ML models 840, and the network entity 802 may select the ML model 810 among the ML models 840. The ML model 810 may be selected based on the UE receiver being evaluated for link adaptation. In some cases, the network entity 802 may select the ML model 810 based on the characteristics of the ML model obtained from the UE 804 as described herein, such as a model identifier, model parameters, layers, structure, neuron connects, etc. In certain cases, the network entity 802 may select the ML model 810 based on an indication of the receiver architecture used at the UE receiver, for example, as further described herein with respect to FIG. 10. For example, the network entity 802 may select the ML model 810 that is trained to predict the response of the receiver architecture indicated by the UE 804.

In certain cases, the ML models 840 may include a set of ML models trained to predict the response of different UE receivers, for example, a different combination of specific types of FFT, channel estimation, channel equalization, and/or demodulation. For example, one ML model may be trained to predict the response of a UE receiver that uses an MMSE-based demodulator, and another ML model may be trained to predict the response of a UE receiver that uses a maximum likelihood-based demodulator. In certain cases, the ML model 810 may be trained to predict the responses of multiple types of UE receivers, and the ML model 810 may output multiple predictions for such UE receiver types.

In some cases, the ML models 840 may predict the response of the UE receiver with different levels of accuracy (e.g., accuracies of 70%, 80%, or 99%), different latencies (e.g., the processing time to predict the response of a UE 804), and/or different throughputs (e.g., the capacity to predict multiple responses of a UE or multiple UEs concurrently). The network entity 802 may select the ML model 810 that is capable of predicting the response of the UE receiver in accordance with certain performance specification(s), such as a certain latency and/or accuracy. The performance specifications for the ML model 810 may depend on a quality of service associated with a service and/or traffic being communicated between the UE and the network entity 802, such as URLLC, mobile broadband, and/or IoT communications.

In certain aspects, the network entity 802 provides input 812 to the ML model 810. The input 812 may include, for example, a signal 816 and/or channel characteristic(s) 818 associated with a communication channel between the network entity 802 and a UE. The signal 816 may include a signal received from a UE (e.g., an SRS) and/or a virtually received signal at the UE 804, which may be simulated based on the channel characteristic(s) 818. The network entity 802 may determine the characteristic(s) 818 associated with the communication channel between the network entity 802 and the UE based on measurements of a signal (e.g., an SRS) received from the UE 804, for example, as described herein with respect FIG. 6.

In certain aspects, the input 812 may further include a PMI 820, a MCS 822, and/or a RI 824 used to simulate the response of the UE receiver. The PMI 820, the MCS 822, and/or the RI 824 may be parameter(s) used to simulate the radio channel conditions (communication conditions) between the network entity 802 and the UE 804. In some cases, the input 812 may include different settings for the PMI 820, the MCS 822, and/or the RI 824, such as different combinations of the PMI 820, the MCS 822, and/or the RI 824. The different settings may allow the ML model 810 to simulate various responses of the UE receiver under a range of communication conditions, such as different beamforming, MCSs, and/or MIMO layer(s). For example, different settings for the PMI may simulate different transmit beamforming settings used at the network entity 802, including, for example, an angle of arrival (AoA), angle of departure (AoD), gain, phase, directivity, beam width, beam direction (with respect to a plane of reference) in terms of azimuth and/or elevation, peak-to-side-lobe ratio, and/or an antenna port associated with the antenna (radiation) pattern. Different settings for the MCS may effectively simulate different throughput rates or data transfer rates used for virtual transmissions from the network entity 802. Different RI settings may simulate different numbers of MIMO layers used for the virtual transmissions from the network entity 802.

The ML model 810 outputs one or more predictions for the response of the UE receiver, for example, under various communication conditions. More specifically, the network entity 802 obtains from the ML model 810 output 826, which may include a decodable indicator 828 and/or an indication of the mutual information 830 (e.g., channel capacity) decoded using the digital representation of the UE receiver. The decodable indicator 828 may include an indication of whether a cyclic redundancy check (CRC) is capable of being passed or failed at the UE receiver under particular communication conditions (e.g., channel characteristics, PMI, MCS, and/or RI settings). In some cases, the decodable indicator 828 may include an indication of whether a virtually received signal is successfully decoded. For example, the ML model 810 may simulate the UE receiver decoding a received signal under various communication conditions, for example, as described herein with respect to FIG. 5, where the decodable indicator 828 may indicate whether the received signal is successfully decoded. The mutual information 830 may indicate the channel capacity of the communication channel between the network entity 802 and the UE 804, for example, as described herein with respect to FIG. 5.

The network entity 802 may use the output 826 to determine certain link adaptation parameter(s) (e.g., the MCS, PMI, and/or RI) for the communication channel between the network entity 802 and the UE 804.

The network entity 802 may select the link adaptation parameters that enable the greatest throughput as predicted by the output 826 (e.g., the mutual information 830) the ML model 810. For example, the ML model 810 may output first mutual information based on a first set of channel characteristics, PMI, MCS, and/or RI settings; and the ML model 810 may output second mutual information based on a second set of channel characteristics, PMI, MCS, and/or RI settings, where the second mutual information may be greater than the first mutual information. In such a case, the network entity 802 may select the PMI. MCS, and/or RI settings from the second set as the link adaptation parameter for the communication channel. The network entity 802 may determine an action for the UE based on the predicated response of the UE receiver, as described herein with respect to FIG. 7. Use of the ML model 810 for UE receiver response prediction may reduce signaling overhead associated with CSF reporting, increase a tracking rate for link adaptation, increase throughput, reduce latencies, allow for spectral efficiencies, etc.

The ML model 810 may be trained using simulated training data and/or training data sampled/collected at the network entity 802 and/or the UE 804. In certain cases, the network entity 802 and/or the UE 804 may train the ML model 810. The network entity 802 and/or the UE 804 may include the data source 706 and/or the model training host 702 as described herein with respect to FIG. 7. The data source 706 may collect training data and/or performance feedback from the network entity 802 and/or the UE 804 in communication with the network entity 802. As an example, the data source 706 may collect, from the UE 804, training data including, for example, CSF, MCS, mutual information, a data error rate (e.g., a block error rate), and/or an indication of whether a CRC is successfully decoded at the UE. The CSF may include the PMI and/or RI (as determined at the UE 804) and indicate the channel characteristics for the communication link between the UE 804 and the network entity 802.

The model training host 702 may train the ML model 810 by providing various training data (e.g., various channel conditions/characteristics and combinations of PMI, MCS, and/or RI) as input to the ML model 810 and evaluate the output 826 (e.g., mutual information, data error rate, and/or the indication of whether the CRC is successfully decoded at the UE). The output 826 of the ML model 810 may be evaluated based on comparing the output 826 to the relevant portions of the training data, such as the mutual information, data error rate, and/or the indication of whether the CRC is successfully decoded at the UE corresponding to the input 812 that is part of the training data. For example, the mutual information that corresponds to a particular PMI and/or RI received from the UE as training data may be used to evaluate the mutual information output by the ML model for the same set of PMI and/or RI fed as input to the ML model 810. If the amount of predicted mutual information is within a margin of error (e.g., ±1, 5, or 10%) from the actual mutual information decoded at the UE, the ML model 810 may be considered to be trained; otherwise, the ML model 810 may continue to be trained (e.g., by adjusting coefficients and/or weights of the ML model 810). In some cases, the ML model training may be evaluated based on whether the CRC is successfully decoded at the UE for the PMI, MCS, and/or RI used at the UE and provided as input to the ML model.

In certain aspects, the ML model training may be evaluated with the objective of satisfying a certain level of performance for the communication link. For example, the data error rate may indicate the performance of the communication link, and the ML model 810 may be trained to reach a certain level for the data error rate (e.g., less than 2, 5, or 10%). Note that the data error rate is an example of a metric for evaluating the performance of the communication link. Other metric(s) may be used in addition to or instead of the data error rate including, for example, an CQI, a signal-to-noise ratio (SNR), an SINR, a signal-to-noise-plus-distortion ratio (SNDR), a received signal strength indicator (RSSI), an RSR), and/or a reference signal received quality (RSRQ).

In certain aspects, a scoring system may be used to evaluate the predictions of the ML model 810. In some cases, the margin of error between the actual mutual information and the predicted mutual information may be used as a score for the model training. In some cases, a score for the model training may be to compare whether the prediction that the CRC is decoded at the UE matches with the UE successfully or not successfully decoding the CRC. Parameters of the ML model 810 may be adjusted based on the scored results. For example, neuron weights of an ANN and/or the number of neuron layers of the ANN may be adjusted based on the score of the ML model 810.

In certain aspects, the ML model training may be performed for specific types of UEs, such as UEs and/or modems (e.g., the modulator and/or demodulator of transceiver 354 of FIG. 3) designed by a particular entity. The entity may be or include a vendor, a manufacturer, and/or a supplier of UEs and/or UE hardware (such as a modem, system-on-chip (SoC), and/or system-in-package (SiP)). As an example, the entity may design and train the ML model 810, and via the training, the entity determines characteristics associated with the trained ML model, such as the model structure, model type, coefficient(s), weight(s), number of layers, interconnections between neurons, etc. used to configure the ML model 810. The entity may configure the UE 804 with such characteristics (e.g., stored in the memory 382), and the UE 804 may send an indication of the characteristics associated with the ML model 810 to the network entity 802 as described herein. In certain aspects, the UE 804 may update the characteristics associated with the ML model 810 through retraining of the ML model 810 (which may be performed at the UE 804 and/or by the entity), and the UE 804 may notify the network entity 802 of such updated characteristics, or vice versa (e.g., the network entity 802 performs the training and notifies the UE 804 of the update(s)).

FIG. 9 is an illustrative diagram of an example artificial neural network (ANN) 900 that may be trained to predict a response of a UE receiver, for example, as described herein with respect to FIG. 8.

ANN 900 may receive input data 906 which may include one or more bits of data 902, pre-processed data output from pre-processor 904 (optional), or some combination thereof. Here, data 902 may include training data, verification data, application-related data, or the like, e.g., depending on the stage of development and/or deployment of ANN 900. Pre-processor 904 may be included within ANN 900 in some other implementations. Pre-processor 904 may, for example, process all or a portion of data 902 which may result in some of data 902 being changed, replaced, deleted, etc. In some implementations, pre-processor 904 may add additional data to data 902.

ANN 900 includes at least one first layer 908 of artificial neurons 910 to process input data 906 and provide resulting first layer data via edges 912 to at least a portion of at least one second layer 914. Second layer 914 processes data received via edges 912 and provides second layer output data via edges 916 to at least a portion of at least one third layer 918. Third layer 918 processes data received via edges 916 and provides third layer output data via edges 920 to at least a portion of a final layer 922 including one or more neurons to provide output data 924. All or part of output data 924 may be further processed in some manner by (optional) post-processor 926. Thus, in certain examples, ANN 900 may provide output data 928 that is based on output data 924, post-processed data output from post-processor 926, or some combination thereof. Post-processor 926 may be included within ANN 900 in some other implementations. Post-processor 926 may, for example, process all or a portion of output data 924 which may result in output data 928 being different, at least in part, to output data 924, e.g., as result of data being changed, replaced, deleted, etc. In some implementations, post-processor 926 may be configured to add additional data to output data 924. In this example, second layer 914 and third layer 918 represent intermediate or hidden layers that may be arranged in a hierarchical or other like structure. Although not explicitly shown, there may be one or more further intermediate layers between the second layer 914 and the third layer 918.

The structure and training of artificial neurons 910 in the various layers may be tailored to specific requirements of an application. Within a given layer of an ANN, some or all of the neurons may be configured to process information provided to the layer and output corresponding transformed information from the layer. For example, transformed information from a layer may represent a weighted sum of the input information associated with or otherwise based on a non-linear activation function or other activation function used to “activate” artificial neurons of a next layer. Artificial neurons in such a layer may be activated by or be responsive to weights and biases that may be adjusted during a training process. Weights of the various artificial neurons may act as parameters to control a strength of connections between layers or artificial neurons, while biases may act as parameters to control a direction of connections between the layers or artificial neurons. An activation function may select or determine whether an artificial neuron transmits its output to the next layer or not in response to its received data. Different activation functions may be used to model different types of non-linear relationships. By introducing non-linearity into an ML model, an activation function allows the ML model to “learn” complex patterns and relationships in the input data 906. Some non-exhaustive example activation functions include a sigmoid based activation function, a “tanh” based activation function, a convolutional activation function, up-sampling, pooling, and a rectified linear unit (ReLU) based activation function.

Design tools (such as computer applications, programs, etc.) may be used to select appropriate structures for ANN 900 and a number of layers and a number of artificial neurons in each layer, as well as selecting activation functions, a loss function, training processes, etc. Once an initial model has been designed, training of the model may be conducted using training data. Training data may include one or more datasets within which ANN 900 may detect, determine, identify or ascertain patterns. Training data may represent various types of information, including written, visual, audio, environmental context, operational properties, etc. During training, parameters of artificial neurons 910 may be changed, such as to minimize or otherwise reduce a loss function or a cost function. A training process may be repeated multiple times to fine-tune ANN 900 with each iteration.

Various ANN model structures are available for consideration. For example, in a feedforward ANN structure each artificial neuron 910 in a layer receives information from the previous layer and likewise produces information for the next layer. In a convolutional ANN structure, some layers may be organized into filters that extract features from data (e.g., training data and/or input data). In a recurrent ANN structure, some layers may have connections that allow for processing of data across time, such as for processing information having a temporal structure, such as time series data forecasting. In an autoencoder ANN structure, compact representations of data may be processed and the model trained to predict or potentially reconstruct original data from a reduced set of features. An autoencoder ANN structure may be useful for tasks related to dimensionality reduction and data compression. A generative adversarial ANN structure may include a generator ANN and a discriminator ANN that are trained to compete with each other. Generative-adversarial networks (GANs) are ANN structures that may be useful for tasks relating to generating synthetic data or improving the performance of other models. A transformer ANN structure makes use of attention mechanisms that may enable the model to process input sequences in a parallel and efficient manner. An attention mechanism allows the model to focus on different parts of the input sequence at different times. Attention mechanisms may be implemented using a series of layers known as attention layers to compute, calculate, determine or select weighted sums of input features based on a similarity between different elements of the input sequence. A transformer ANN structure may include a series of feedforward ANN layers that may “learn” non-linear relationships between the input and output sequences. The output of a transformer ANN structure may be obtained by applying a linear transformation to the output of a final attention layer. A transformer ANN structure may be of particular use for tasks that involve sequence modeling, or other like processing. Another example type of ANN structure, is a model with one or more invertible layers. Models of this type may be inverted or “unwrapped” to reveal the input data that was used to generate the output of a layer. Other example types of ANN model structures include fully connected neural networks (FCNNs) and long short-term memory (LSTM) networks.

ANN 900 or other ML models may be implemented in various types of processing circuits along with memory and applicable instructions therein. For example, general-purpose hardware circuits, such as, such as one or more central processing units (CPUs) and one or more graphics processing units (GPUs) may be employed to implement a model. One or more tensor processing units (TPUs), embedded neural processing units (eNPUs) or other like more special-purpose processors, and/or field-programmable gate arrays (FPGAs), application-specific integrated circuits (ASICs), or the like also may be employed. Various programming tools are available for developing ANN models. For example, some open-source tools include TensorFlow® provided by Google Inc., PyTorch® provided by Facebook, Inc., and MXNet™ provided by the Apache® Software Foundation (ASF). Additionally, various other tools may be used that may or may not be considered open-source tools.

There are a variety of model training techniques and processes that may be used prior to, or at some point following, deployment of an ML model, such as ANN 900.

As part of a model development process, information in the form of applicable training data may be gathered or otherwise created for use in training an ML model accordingly. For example, training data may be gathered or otherwise created regarding information associated with received/transmitted signal strengths, interference, and resource usage data, as well as any other relevant data that might be useful for training a model to address one or more problems or issues in a communication system. In certain instances, all or part of the training data may originate in one or more user equipments (UEs), one or more network entities, or one or more other devices in a wireless communication system. In some cases, all or part of the training data may be aggregated from multiple sources (e.g., one or more UEs, one or more network entities, the Internet, etc.). For example, wireless network architectures, such as self-organizing networks (SONs) or mobile drive test (MDT) networks, may be adapted to support collection of data for ML model applications. In another example, training data may be generated or collected online, offline, or both online and offline by a UE, network entity, or other device(s), and all or part of such training data may be transferred or shared (in real or near-real time), such as through store and forward functions or the like. Offline training may refer to creating and using a static training dataset. e.g., in a batched manner, whereas online training may refer to a real-time or near-real-time collection and use of training data. For example, an ML model at a wireless communications device (e.g., a UE) may be trained and/or fine-tuned using online or offline training. For offline training, data collection and training can occur in an offline manner at the network side (e.g., at a base station or other network entity) or at the UE side. With respect to an ML model deployed at or on a network entity (for example, as described herein with respect to FIG. 8), offline training may occur at a separate computing device, such as an edge computing device, a core network and/or a RAN controller (e.g., a near-RT RIC and/or a Non-RT RIC). For online training, the training of an ML model may be performed locally at the UE or at a separate computing device (e.g., a server hosted by a UE vendor and/or network operator) in a real-time or near-real-time manner based on data provided to the server device from the UE. With respect to an ML model deployed at or on a network entity (for example, as described herein with respect to FIG. 8), online training may occur locally at the network entity or at a separate computing device, such as an edge computing device, a core network and/or a RAN controller (e.g., a near-RT RIC and/or a Non-RT RIC).

In certain instances, all or part of the training data may be shared within a wireless communication system, or even shared (or obtained from) outside of the wireless communication system.

Once an ML model has been “trained” with training data, its performance may be evaluated. In some scenarios, evaluation/verification tests may use a validation dataset, which may include data not in the training data, to compare the model's performance to baseline or other benchmark information. If model performance is deemed unsatisfactory, it may be beneficial to fine-tune the model, e.g., by changing its architecture, re-training it on the data, or using different optimization techniques, etc. Once a model's performance is deemed satisfactory, the model may be deployed accordingly. In certain instances, a model may be updated in some manner. e.g., all or part of the model may be changed or replaced, or undergo further training, just to name a few examples.

As part of a training process for an ANN, parameters affecting the functioning of the artificial neurons and layers may be adjusted. For example, backpropagation techniques may be used to train the ANN by iteratively adjusting weights or biases of certain artificial neurons associated with errors between a predicted output of the model and a desired output that may be known or otherwise deemed acceptable. Backpropagation may include a forward pass, a loss function, a backward pass, and a parameter update that may be performed in training iteration. The process may be repeated for a certain number of iterations for each set of training data until the weights of the artificial neurons/layers are adequately tuned. Backpropagation techniques associated with a loss function may measure how well a model is able to predict a desired output for a given input. An optimization algorithm may be used during a training process to adjust weights/biases to reduce or minimize the loss function which should improve the performance of the model. There are a variety of optimization algorithms that may be used along with backpropagation techniques or other training techniques. Some initial examples include a gradient descent based optimization algorithm and a stochastic gradient descent based optimization algorithm. A stochastic gradient descent technique may be used to adjust weights/biases in order to minimize or otherwise reduce a loss function. A mini-batch gradient descent technique, which is a variant of gradient descent, may involve updating weights/biases using a small batch of training data rather than the entire dataset. A momentum technique may accelerate an optimization process by adding a momentum term to update or otherwise affect certain weights/biases. An adaptive learning rate technique may adjust a learning rate of an optimization algorithm associated with one or more characteristics of the training data. A batch normalization technique may be used to normalize inputs to a model in order to stabilize a training process and potentially improve the performance of the model. A “dropout” technique may be used to randomly drop out some of the artificial neurons from a model during a training process, e.g., in order to reduce overfitting and potentially improve the generalization of the model. An “early stopping” technique may be used to stop an on-going training process early, such as when a performance of the model using a validation dataset starts to degrade. Another example technique includes data augmentation to generate additional training data by applying transformations to all or part of the training information. A transfer learning technique may be used which involves using a pre-trained model as a starting point for training a new model, which may be useful when training data is limited or when there are multiple tasks that are related to each other. A multi-task learning technique may be used which involves training a model to perform multiple tasks simultaneously to potentially improve the performance of the model on one or more of the tasks. Hyperparameters or the like may be input and applied during a training process in certain instances.

Another example technique that may be useful with regard to an ML model is some form of a “pruning” technique. A pruning technique, which may be performed during a training process or after a model has been trained, involves the removal of unnecessary or less necessary, or possibly redundant features from a model. In certain instances, a pruning technique may reduce the complexity of a model or improve efficiency of a model without undermining the intended performance of the model. Pruning techniques may be particularly useful in the context of wireless communication, where the available resources (such as power and bandwidth) may be limited Some example pruning techniques include a weight pruning technique, a neuron pruning technique, a layer pruning technique, a structural pruning technique, and a dynamic pruning technique Pruning techniques may, for example, reduce the amount of data corresponding to a model that may need to be transmitted or stored. Weight pruning techniques may involve removing some of the weights from a model. Neuron pruning techniques may involve removing some neurons from a model. Layer pruning techniques may involve removing some layers from a model. Structural pruning techniques may involve removing some connections between neurons in a model. Dynamic pruning techniques may involve adapting a pruning strategy of a model associated with one or more characteristics of the data or the environment. For example, in certain wireless communication devices, a dynamic pruning technique may more aggressively prune a model for use in a low-power or low-bandwidth environment, and less aggressively prune the model for use in a high-power or high-bandwidth environment. In certain example implementations, pruning techniques also may be applied to training data. e.g., to remove outliers, etc. In some implementations, pre-processing techniques directed to all or part of a training dataset may improve model performance or promote faster convergence of a model. For example, training data may be pre-processed to change or remove unnecessary data, extraneous data, incorrect data, or otherwise identifiable data. Such pre-processed training data may, for example, lead to a reduction in potential overfitting, or otherwise improve the performance of the trained model.

One or more of the example training techniques presented above may be employed as part of a training process. Some example training processes that may be used to train an ML model include supervised learning, unsupervised learning, semi-supervised learning, and reinforcement learning technique. With supervised learning, a model is trained on a labeled training dataset, wherein the input data is accompanied by a correct or otherwise acceptable output. With unsupervised learning, a model is trained on an unlabeled training dataset, such that the model will need to learn to identify patterns and relationships in the data without the explicit guidance of a labeled training dataset. With semi-supervised learning, a model is trained using some combination of supervised and unsupervised learning processes, for example, when the amount of labeled data is somewhat limited. With reinforcement learning, a model may learn from interactions with its operation/environment, such as in the form of feedback akin to rewards or penalties. Reinforcement learning may be particularly beneficial when used to improve or attempt to optimize a behavior of a model deployed in a dynamically changing environment, such as a wireless communication network.

Distributed or shared learning, such as federated learning, may enable training on data distributed across multiple devices or organizations, without the need to centralize data or the training. Federated learning may be particularly useful in scenarios where data is sensitive or subject to privacy constraints, or where it is impractical, inefficient, or expensive to centralize data. In the context of wireless communication, for example, federated learning may be used to improve performance by allowing an ML model to be trained on data collected from a wide range of devices and environments. For example, an ML model may be trained on data collected from a large number of wireless devices in a network, such as distributed wireless communication nodes, smartphones, or internet-of-things (IoT) devices, to improve the network's performance and efficiency. With federated learning, a user equipment (UE) or other device may receive a copy of all or part of a model and perform local training on such copy of all or part of the model using locally available training data. Such a device may provide updated information (e.g., coefficients, weights, number of layers, kernel size or dimensions, zero padding, linear operations, etc.) regarding the locally trained model to one or more other devices (such as a network entity or a server) where the updates from other-like devices (such as other UEs) may be aggregated and used to provide an update to a shared model or the like. A federated learning process may be repeated iteratively until all or part of a model obtains a satisfactory level of performance. Federated learning may enable devices to protect the privacy and security of local data, while supporting collaboration regarding training and updating of all or part of a shared model.

In some implementations, one or more devices or services may support processes relating to a ML model's usage, maintenance, activation, reporting, or the like. In certain instances, all or part of a dataset or model may be shared across multiple devices, e.g., to provide or otherwise augment or improve processing. In some examples, signaling mechanisms may be utilized at various nodes of wireless network to signal the capabilities for performing specific functions related to ML model, support for specific ML models, capabilities for gathering, creating, transmitting training data, or other ML related capabilities. ML models in wireless communication systems may, for example, be employed to support decisions relating to wireless resource allocation or selection, wireless channel condition estimation, interference mitigation, beam management, positioning accuracy, energy savings, or modulation or coding schemes, etc. In some implementations, model deployment may occur jointly or separately at various network levels, such as, a CU, DU, RU, Non-RT RIC, RT-RIC, SMO, core network, or the like.

### Example Receiver Architecture Mapping

In certain aspects, the network entity may obtain an indication of the UE receiver via a receiver architecture mapping that identifies one or more signal decoding operations and/or a number of receive antennas used at a UE receiver. As an example, a receiver architecture index may correspond to one or more decoding operations of a UE receiver, such as the operations described herein with respect to FIG. 5. In some cases, the network entity may use the indication of the receiver architecture to train, configure, or select an ML model that is trained to predict a response of the indicated receiver architecture. In certain cases, in a simulation (such as without an ML model), the network entity may perform the decoding operations associated with the indicated receiver architecture to estimate the response of the UE receiver.

FIG. 10 is a diagram illustrating an example mapping scheme 1000 that maps a receiver architecture to various types of signal decoding operations used at a UE receiver. In this example, the mapping scheme 1000 defines a plurality of receiver architecture indices 1002a, 1002b, and 1002c (collectively receiver architecture indices 1002). Each of the receiver architecture indices 1002 correspond to one or more decoding operations (e.g., 1004-1010) and/or a number of receive antennas 1012 employed at a UE receiver. As an example, the first receiver architecture index 1002a maps to an FFT type 1004 (e.g., a radix-2, radix-4, or radix-8 FFT architecture), a channel estimation type 1006 (e.g., frequency domain MMSE, time domain MMSE, etc.), a channel equalization type 1008 (e.g., MMSE, blind equalization, adaptive median filter, etc.), and/or a demodulation type 1010 (e.g., MMSE, maximum likelihood, etc.). Note that other decoding operations may be associated with a receiver architecture index in addition to or instead of the types of decoding operations depicted in FIG. 10. In certain aspects, a UE may send, to a network entity, an indication of the UE receiver used at the UE via the mapping scheme 1000. For example, the UE may send, to the network entity, an indication of the first receiver architecture index 1002a that corresponds to the receiver architecture implemented at the UE.

### Example Operations of Entities in a Communications Network

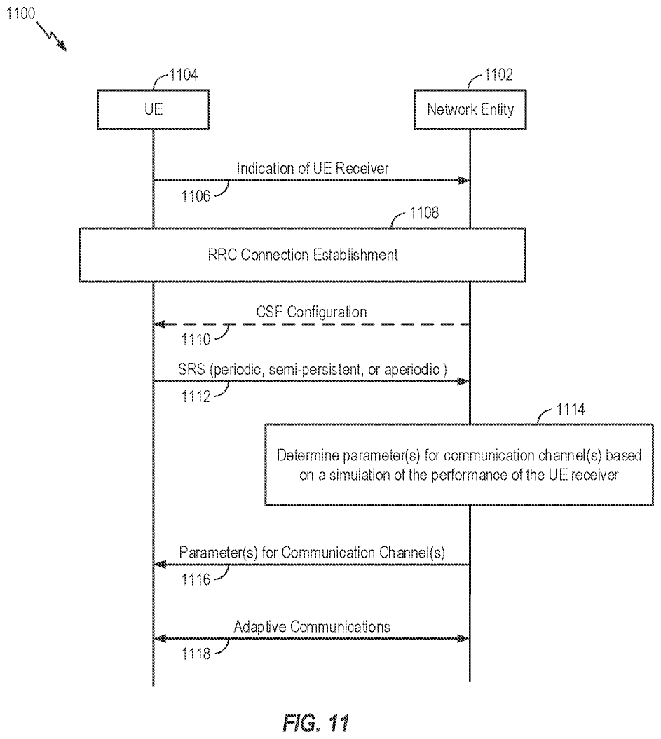

FIG. 11 depicts a process flow 1100 for communications in a network between a network entity 1102 and an UE 1104. In some aspects, the network entity 1102 may be an example of the BS 102 depicted and described with respect to FIGS. 1 and 3 or a disaggregated base station depicted and described with respect to FIG. 2. Similarly, the UE 1104 may be an example of UE 104 depicted and described with respect to FIGS. 1 and 3. However, in other aspects, UE 1104 may be another type of wireless communications device and network entity 1102 may be another type of network entity or network node, such as those described herein.

At 1106, the network entity 1102 obtains an indication of a UE receiver employed at the UE 1104. In some cases, the network entity 1102 may obtain capability information that includes the indication of the UE receiver. The indication of the UE receiver may include an indication of an ML model that is trained to predict a response of the UE receiver, for example, as described herein with respect to FIGS. 8 and 9. In some cases, the indication of the UE receiver may include an indication of a receiver architecture associated with the UE receiver used at the UE 1104, for example, as described herein with respect to FIG. 10. The indication of the ML model may include parameters associated with an ANN, such as weights, coefficients, neuron connections, and/or the number of layers of an ANN. In certain aspects, the network entity 1102 may obtain the indication of the UE receiver while the UE 1104 is in an idle mode or inactive mode.

At 1108, the UE 1104 establishes an RRC connection with the network entity 1102. For example, an RRC setup procedure may be performed to establish the RRC connection. In an RRC connected state, the UE 1104 may communicate with the network entity 1102 via a data radio bearer, for example, to transfer application data between the UE 1104 and the network entity 1102.

At 1110, the network entity 1102 may send, to the UE 1104 a CSF configuration that indicates when to report CSF to the network entity 1102. The CSF configuration may facilitate a reduction in signaling overhead used for CSF reporting. The CSF configuration may reduce the rate of communicating CSF to the network entity 1102. For example, the CSF configuration may increase the period of the periodicity for reporting the CSF or indicate to only report aperiodic CSF to the network entity 1102. In some cases, the CSF configuration may disable periodic or semi-persistent CSF from being reported. In certain cases, the CSF configuration may enable aperiodic CSF to be reported in accordance with certain aperiodic triggers, such as DCI trigger. The CSF configuration may be sent in response to obtaining the UE capability information indicating support for the digital representation of the UE receiver at 1106.

At 1112, the network entity 1102 obtains a reference signal (e.g., an SRS) from the UE 1104, for example, as described herein with respect to FIG. 5. The reference signal may be obtained on a periodic basis (e.g., a periodic or semi-persistent reference signal) and/or on an aperiodic basis (e.g., triggered by control signaling or another event). The network entity 1102 determines channel characteristics of a communication channel between the network entity 1102 and the UE 1104 based on measurements of the signal received from the UE 1104. The channel characteristics of the communication channel may allow the network entity 1102 to estimate the effects of a channel on a signal transmitted from the network entity 1102 and received at the UE 1104.

At 1114, the network entity 1102 determines parameter(s) (e.g., the MCS, PMI, and/or RI) for one or more communication channel(s) between the UE 1104 and the network entity 1102 based on a simulation of the performance of the UE receiver. In some cases, the network entity 1102 estimates a response of the UE receiver using an ML model trained to predict the response of the UE receiver, for example, as described herein with respect to FIG. 8. The network entity 1102 may configure, select, and/or train the ML model according to the parameter(s) or characteristic(s) associated with the ML model obtained at 1106. In certain cases, under the simulation, the network entity 1102 performs the various decoding operations (e.g., the specific types of channel estimation, channel equalization, demodulation, etc.) used at the UE receiver as indicated by the receiver architecture obtained at 1106.

At 1116, the network entity 1102 sends, to the UE 1104, the parameter(s) for the communication channel(s). For example, the parameter(s) may include the MCS, the beamforming, and/or the number of MIMO layers to use on the communication channel(s). Note that these parameters are examples, and other link adaptation parameters may be used instead of or in addition to those described herein. For example, the parameter(s) may include the code rate (e.g., the proportion of the data-stream that is non-redundant), the number of aggregated carriers, the channel bandwidth, the subcarrier spacing, the frequency range (e.g., FR1 or FR2 under 5G NR), etc.

At 1118, the UE 1104 communicates with the network entity 1102 via adaptive communications. For example, the operations at 1112, 1114, and 1116 may be repeated to adapt to time-varying channel conditions between the UE 1104 and the network entity 1102. It will be appreciated that the simulated response of the UE receiver as described herein may facilitate a reduction in the CSF overhead (allowing for spectral, time domain, and spatial efficiencies) and/or a higher tracking rate for link adaptation.

### Example Operations of a Network Entity

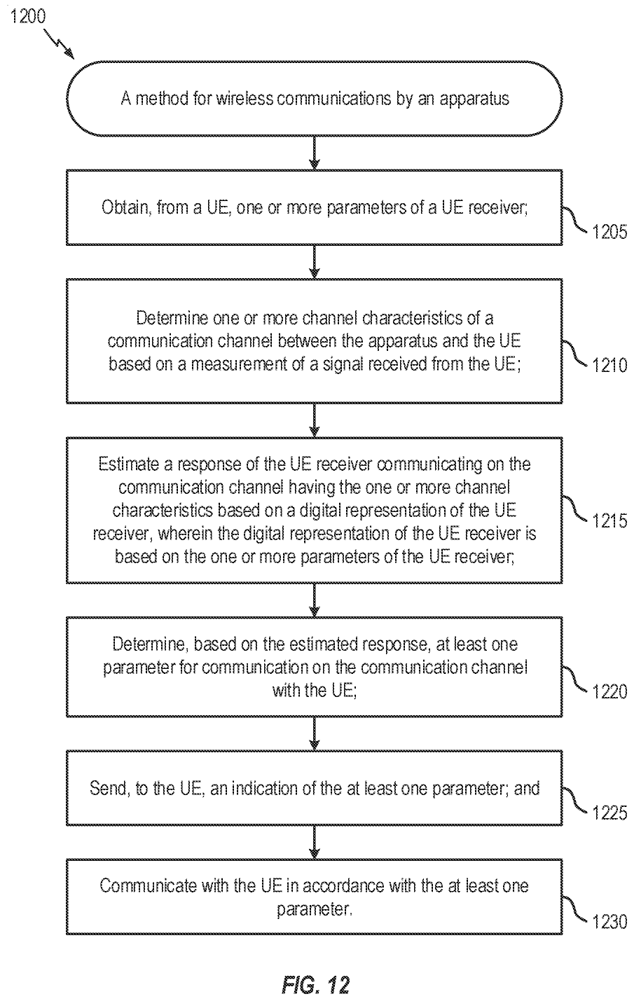

FIG. 12 shows a method 1200 for wireless communications by an apparatus, such as BS 102 of FIGS. 1 and 3, or a disaggregated base station as discussed with respect to FIG. 2.

Method 1200 begins at block 1205 with obtaining, from a UE, one or more parameters of a UE receiver (e.g., the receiver 502 of FIG. 5). The parameter(s) may include one or more characteristics associated with an ML model as described herein with respect to FIG. 8. For example, the parameter(s) may include coefficients and/or weights used in an ANN, an indication of the architecture or structure of the ML model (e.g., the connections for artificial neurons and/or the number of layers of artificial neurons), training data used to train the ML model, and/or an identifier for the ML model. In some cases, the parameter(s) may include an indication of the architecture of the UE receiver, for example, as described herein with respect to FIG. 10. As an example, the parameter(s) may include a receiver architecture index that maps to one or more decoding operations and/or a number of receive antennas employed at the UE receiver.

Method 1200 then proceeds to block 1210 with determining one or more channel characteristics of a communication channel between the apparatus and the UE based on a measurement of a signal received from the UE, for example, as described herein with respect to FIG. 6. As an example, a network entity may receive an SRS from the UE, and the network entity may determine the channel characteristics of the communication channel based on measurement(s) of the SRS.

Method 1200 then proceeds to block 1215 with estimating a response of the UE receiver communicating on the communication channel having the one or more channel characteristics based on a digital representation of the UE receiver, wherein the digital representation of the UE receiver is based on the one or more parameters of the UE receiver, for example, as described herein with respect to FIG. 8. The estimated response may include, for example, the decodable indicator 828 and/or an indication of the mutual information 830 of FIG. 8. As an example, a network entity may obtain, from an ML model, a prediction (e.g., the decodable indicator 828) that a received signal is decodable at the UE receiver under channel conditions as represented by the one or more channel characteristics and using a certain combination of PMI, RI, and/or MCS for the communication between the network entity and the UE.

Method 1200 then proceeds to block 1220 with determining, based on the estimated response, at least one parameter for communication on the communication channel with the UE, for example, as described herein with respect to FIG. 8. The at least one parameter may include a link adaptation parameter, such as the PMI, RI, and/or MCS.

Method 1200 then proceeds to block 1225 with sending, to the UE, an indication of the at least one parameter, for example, as described herein with respect to FIG. 11. In certain aspects, a network entity may send the at least one parameter via control signaling, such as RRC signaling, MAC signaling, DCI, sidelink control information (SCI), and/or system information.

Method 1200 then proceeds to block 1230 with communicating with the UE in accordance with the at least one parameter, for example, as described herein with respect to FIG. 11. For example, a network entity may send a signal (e.g., carrying data and/or control information) to the UE on the communication channel using an MCS, transmit beamforming, and/or the number of MIMO layers indicated by the at least one parameter.

In certain aspects, the digital representation comprises a machine learning model configured (e.g., trained) to estimate the response of the UE receiver, and wherein the one or more parameters comprise one or more coefficients for the machine learning model, for example, as described herein with respect to FIG. 8. In certain aspects, block 1215 comprises providing, to the machine learning model, input comprising the one or more channel characteristics; and obtaining, from the machine learning model, output comprising the estimated response. In certain aspects, the estimated response comprises an indication of mutual information decoded via the digital representation of the UE receiver. In certain aspects, block 1215 comprises providing, to the machine learning model, input comprising one or more combinations of inputs, each of the one or more combinations of inputs comprising the one or more channel characteristics and one or more of a respective MCS, a respective PMI, or a respective RI; and for each of the one or more combinations of inputs, obtaining, from the machine learning model, output comprising an indication of whether the respective combination of inputs passes a CRC as the estimated response. In certain aspects, the at least one parameter comprises the one or more of the respective MCS, the respective PMI, or the respective RI of one of the one or more combinations of inputs that would pass the CRC.

In certain aspects, the one or more parameters comprise a receiver index indicating a receiver architecture of the UE receiver, for example, as described herein with respect to FIG. 10. In certain aspects, the receiver architecture comprises one or more of: a channel estimation type or a demodulator type. In certain aspects, the channel estimation type comprises one or more of: frequency domain MMSE-based channel estimation, or time domain MMSE-based channel estimation. In certain aspects, the demodulator type comprises one or more of: a MMSE-based demodulator, or a maximum likelihood-based demodulator.

In certain aspects, the one or more parameters further comprise a number of receive antennas of the UE, for example, as described herein with respect to FIG. 10.

In certain aspects, block 1205 comprises obtaining the one or more parameters prior to RRC connection establishment between the apparatus and the UE, for example, as described herein with respect to FIG. 11.

In certain aspects, method 1200 further includes sending an indication to the UE to reduce a rate of communicating CSF in response to obtaining the one or more parameters, for example, as described herein with respect to FIG. 11.

In certain aspects, the at least one parameter comprises: a MCS, a PMI, a RI, or a combination thereof, for example, as described herein with respect to FIG. 11.

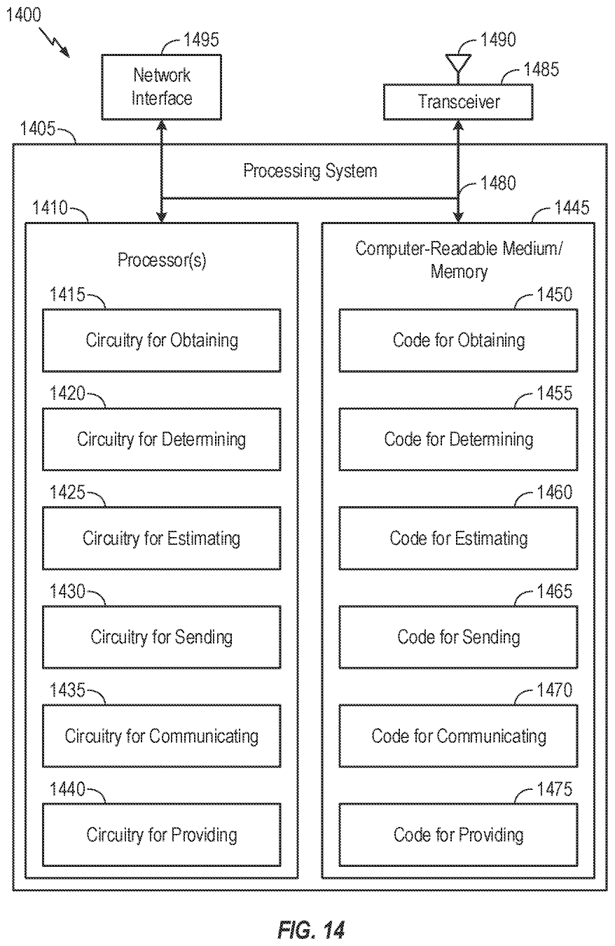

In certain aspects, method 1200, or any aspect related to it, may be performed by an apparatus, such as communications device 1400 of FIG. 14, which includes various components operable, configured, or adapted to perform the method 1200. Communications device 1400 is described below in further detail.

Note that FIG. 12 is just one example of a method, and other methods including fewer, additional, or alternative operations are possible consistent with this disclosure.

### Example Operations of a User Equipment

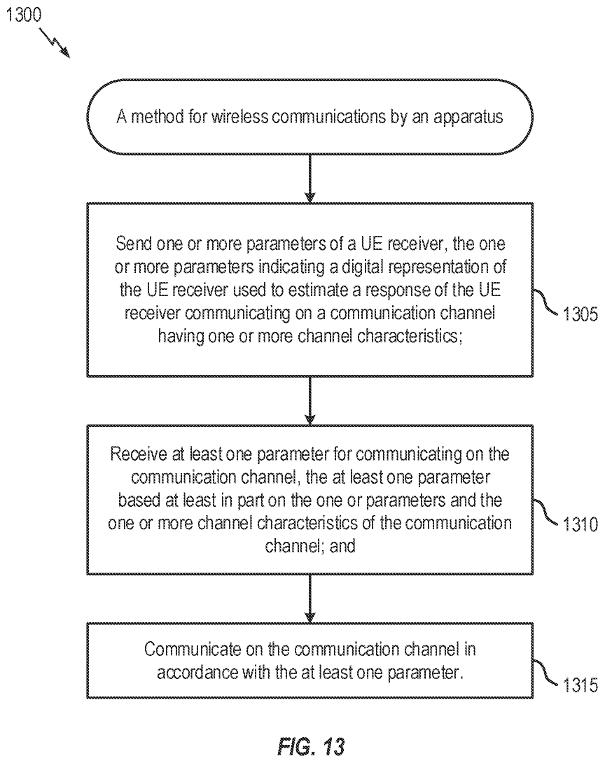

FIG. 13 shows a method 1300 for wireless communications by an apparatus, such as UE 104 of FIGS. 1 and 3.

Method 1300 begins at block 1305 with sending one or more parameters of a UE receiver (e.g., the receiver 508 of FIG. 5), the one or more parameters indicating a digital representation of the UE receiver used to estimate a response of the UE receiver communicating on a communication channel having one or more channel characteristics. The parameter(s) may include one or more characteristics associated with an ML model as described herein with respect to FIG. 8. For example, the parameter(s) may include coefficients and/or weights used in an ANN, an indication of the architecture or structure of the ML model (e.g., the connections for artificial neurons and/or the number of layers of artificial neurons), training data used to train the ML model, and/or an identifier for the ML model. In some cases, the parameter(s) may include an indication of the architecture of the UE receiver, for example, as described herein with respect to FIG. 10. As an example, the parameter(s) may include a receiver architecture index that maps to one or more decoding operations and/or a number of receive antennas employed at the UE receiver.

Method 1300 then proceeds to block 1310 with receiving at least one parameter for communicating on the communication channel, the at least one parameter based at least in part on the one or parameters and the one or more channel characteristics of the communication channel, for example, as described herein with respect to FIG. 11. The at least one parameter may include a link adaptation parameter, such as the PMI, RI, and/or MCS. In certain aspects, a UE may receive the at least one parameter via control signaling, such as RRC signaling, MAC signaling. DCI, sidelink control information (SCI), and/or system information.

Method 1300 then proceeds to block 1315 with communicating on the communication channel in accordance with the at least one parameter, for example, as described herein with respect to FIG. 11. For example, a UE may receive a signal (e.g., carrying data and/or control information) from a network entity on the communication channel using an MCS, transmit beamforming, and/or the number of MIMO layers indicated by the at least one parameter.

In certain aspects, the digital representation comprises a machine learning model configured to estimate the response of the UE receiver, and wherein the one or more parameters comprise one or more coefficients for the machine learning model, for example, as described herein with respect to FIG. 8.

In certain aspects, the one or more parameters comprise a receiver index indicating a receiver architecture of the UE receiver, for example, as described herein with respect to FIG. 10. In certain aspects, the receiver architecture comprises one or more of: a channel estimation type or a demodulator type. In certain aspects, the channel estimation type comprises one or more of: frequency domain MMSE-based channel estimation, or time domain MMSE-based channel estimation. In certain aspects, the demodulator type comprises one or more of: a MMSE-based demodulator, or a maximum likelihood-based demodulator. In certain aspects, the one or more parameters further comprise a number of receive antennas of the UE.

In certain aspects, method 1300 further includes sending a reference signal on the communication channel, for example, as described herein with respect to FIG. 11.

In certain aspects, block 1305 comprises sending the one or more parameters prior to RRC connection establishment between the apparatus and the UE, for example, as described herein with respect to FIG. 11.

In certain aspects, method 1300 further includes obtaining an indication to reduce a rate of communicating CSF in response to sending the one or more parameters, for example, as described herein with respect to FIG. 11.

In certain aspects, the at least one parameter comprises: an MCS, a PMI, a RI, or a combination thereof, for example, as described herein with respect to FIG. 11.

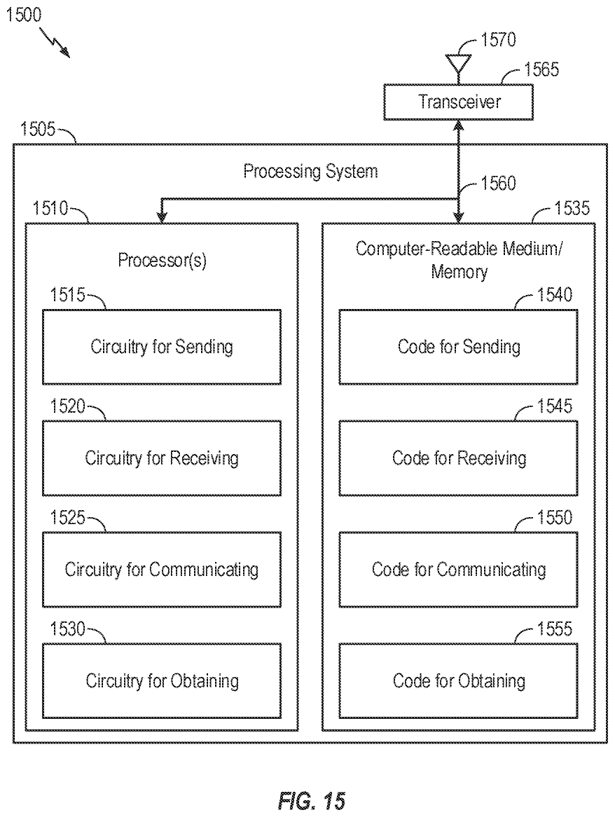

In certain aspects, method 1300, or any aspect related to it, may be performed by an apparatus, such as communications device 1500 of FIG. 15, which includes various components operable, configured, or adapted to perform the method 1300. Communications device 1500 is described below in further detail.

Note that FIG. 13 is just one example of a method, and other methods including fewer, additional, or alternative operations are possible consistent with this disclosure.

### Example Communications Devices

FIG. 14 depicts aspects of an example communications device 1400. In some aspects, communications device 1400 is a network entity, such as BS 102 of FIGS. 1 and 3, or a disaggregated base station as discussed with respect to FIG. 2.

The communications device 1400 includes a processing system 1405 coupled to a transceiver 1485 (e.g., a transmitter and/or a receiver) and/or a network interface 1495. The transceiver 1485 is configured to transmit and receive signals for the communications device 1400 via an antenna 1490, such as the various signals as described herein. The network interface 1495 is configured to obtain and send signals for the communications device 1400 via communications link(s), such as a backhaul link, midhaul link, and/or fronthaul link as described herein, such as with respect to FIG. 2. The processing system 1405 may be configured to perform processing functions for the communications device 1400, including processing signals received and/or to be transmitted by the communications device 1400.

The processing system 1405 includes one or more processors 1410. In various aspects, one or more processors 1410 may be representative of one or more of receive processor 338, transmit processor 320, TX MIMO processor 330, and/or controller/processor 340, as described with respect to FIG. 3. The one or more processors 1410 are coupled to a computer-readable medium/memory 1445 via a bus 1480. In certain aspects, the computer-readable medium/memory 1445 is configured to store instructions (e.g., computer-executable code) that when executed by the one or more processors 1410, enable and cause the one or more processors 1410 to perform the method 1200 described with respect to FIG. 12, or any aspect related to it, including any additional operations described in relation to FIG. 12. Note that reference to a processor of communications device 1400 performing a function may include one or more processors of communications device 1400 performing that function, such as in a distributed fashion.

In the depicted example, the computer-readable medium/memory 1445 stores code for obtaining 1450, code for determining 1455, code for estimating 1460, code for sending 1465, code for communicating 1470, and code for providing 1475. Processing of the code 1450-1475 may enable and cause the communications device 1400 to perform the method 1200 described with respect to FIG. 12, or any aspect related to it.

The one or more processors 1410 include circuitry configured to implement (e.g., execute) the code stored in the computer-readable medium/memory 1445, including circuitry for obtaining 1415, circuitry for determining 1420, circuitry for estimating 1425, circuitry for sending 1430, circuitry for communicating 1435, and circuitry for providing 1440. Processing with circuitry 1415-1440 may enable and cause the communications device 1400 to perform the method 1200 described with respect to FIG. 12, or any aspect related to it.

More generally, means for communicating, transmitting, sending or outputting for transmission may include the transceivers 332, antenna(s) 334, transmit processor 320, TX MIMO processor 330, and/or controller/processor 340 of the BS 102 illustrated in FIG. 3, transceiver 1485 and/or antenna 1490 of the communications device 1400 in FIG. 14, and/or one or more processors 1410 of the communications device 1400 in FIG. 14. Means for communicating, receiving or obtaining may include the transceivers 332, antenna(s) 334, receive processor 338, and/or controller/processor 340 of the BS 102 illustrated in FIG. 3, transceiver 1485 and/or antenna 1490 of the communications device 1400 in FIG. 14, and/or one or more processors 1410 of the communications device 1400 in FIG. 14.

FIG. 15 depicts aspects of an example communications device 1500. In some aspects, communications device 1500 is a user equipment, such as UE 104 described above with respect to FIGS. 1 and 3.

The communications device 1500 includes a processing system 1505 coupled to a transceiver 1565 (e.g., a transmitter and/or a receiver). The transceiver 1565 is configured to transmit and receive signals for the communications device 1500 via an antenna 1570, such as the various signals as described herein. The processing system 1505 may be configured to perform processing functions for the communications device 1500, including processing signals received and/or to be transmitted by the communications device 1500.

The processing system 1505 includes one or more processors 1510. In various aspects, the one or more processors 1510 may be representative of one or more of receive processor 358, transmit processor 364, TX MIMO processor 366, and/or controller/processor 380, as described with respect to FIG. 3. The one or more processors 1510 are coupled to a computer-readable medium/memory 1535 via a bus 1560. In certain aspects, the computer-readable medium/memory 1535 is configured to store instructions (e.g., computer-executable code) that when executed by the one or more processors 1510, enable and cause the one or more processors 1510 to perform the method 1300 described with respect to FIG. 13, or any aspect related to it, including any additional operations described in relation to FIG. 13. Note that reference to a processor performing a function of communications device 1500 may include one or more processors performing that function of communications device 1500, such as in a distributed fashion.

In the depicted example, computer-readable medium/memory 1535 stores code for sending 1540, code for receiving 1545, code for communicating 1550, and code for obtaining 1555. Processing of the code 1540-1555 may enable and cause the communications device 1500 to perform the method 1300 described with respect to FIG. 13, or any aspect related to it.

The one or more processors 1510 include circuitry configured to implement (e.g., execute) the code stored in the computer-readable medium/memory 1535, including circuitry for sending 1515, circuitry for receiving 1520, circuitry for communicating 1525, and circuitry for obtaining 1530. Processing with circuitry 1515-1530 may enable and cause the communications device 1500 to perform the method 1300 described with respect to FIG. 13, or any aspect related to it.

More generally, means for communicating, transmitting, sending or outputting for transmission may include the transceivers 354, antenna(s) 352, transmit processor 364, TX MIMO processor 366, and/or controller/processor 380 of the UE 104 illustrated in FIG. 3, transceiver 1565 and/or antenna 1570 of the communications device 1500 in FIG. 15, and/or one or more processors 1510 of the communications device 1500 in FIG. 15. Means for communicating, receiving or obtaining may include the transceivers 354, antenna(s) 352, receive processor 358, and/or controller/processor 380 of the UE 104 illustrated in FIG. 3, transceiver 1565 and/or antenna 1570 of the communications device 1500 in FIG. 15, and/or one or more processors 1510 of the communications device 1500 in FIG. 15.

### EXAMPLE CLAUSES

Implementation examples are described in the following numbered clauses:

Clause 1: A method for wireless communications by an apparatus, comprising: obtaining, from a UE, one or more parameters of a UE receiver; determining one or more channel characteristics of a communication channel between the apparatus and the UE based on a measurement of a signal received from the UE; estimating a response of the UE receiver communicating on the communication channel having the one or more channel characteristics based on a digital representation of the UE receiver, wherein the digital representation of the UE receiver is based on the one or more parameters of the UE receiver; determining, based on the estimated response, at least one parameter for communication on the communication channel with the UE: sending, to the UE, an indication of the at least one parameter; and communicating with the UE in accordance with the at least one parameter.

Clause 2: The method of Clause 1, wherein the digital representation comprises a machine learning model configured to estimate the response of the UE receiver, and wherein the one or more parameters comprise one or more coefficients for the machine learning model.

Clause 3: The method of Clause 2, further comprising providing, to the machine learning model, input comprising the one or more channel characteristics; and obtaining, from the machine learning model, output comprising the estimated response.

Clause 4: The method of Clause 3, wherein the estimated response comprises an indication of mutual information decoded via the digital representation of the UE receiver.

Clause 5: The method of Clause 2, wherein estimating the response of the UE receiver comprises providing, to the machine learning model, input comprising one or more combinations of inputs, each of the one or more combinations of inputs comprising the one or more channel characteristics and one or more of a respective MCS, a respective PMI, or a respective RI; and for each of the one or more combinations of inputs, obtaining, from the machine learning model, output comprising an indication of whether the respective combination of inputs passes a CRC as the estimated response.

Clause 6: The method of Clause 5, wherein the at least one parameter comprises the one or more of the respective MCS, the respective PMI, or the respective RI of one of the one or more combinations of inputs that would pass the CRC.

Clause 7: The method of any one of Clauses 1-6, wherein the one or more parameters comprise a receiver index indicating a receiver architecture of the UE receiver.

Clause 8: The method of Clause 7, wherein the receiver architecture comprises one or more of, a channel estimation type or a demodulator type.

Clause 9: The method of Clause 8, wherein the channel estimation type comprises one or more of: frequency domain MMSE-based channel estimation, or time domain MMSE-based channel estimation.

Clause 10: The method of Clause 8, wherein the demodulator type comprises one or more of: a MMSE-based demodulator, or a maximum likelihood-based demodulator.

Clause 11: The method of Clause 7, wherein the one or more parameters further comprise a number of receive antennas of the UE.

Clause 12: The method of any one of Clauses 1-11, wherein obtaining the one or more parameters comprises obtaining the one or more parameters prior to RRC connection establishment between the apparatus and the UE.

Clause 13: The method of any one of Clauses 1-12, further comprising: sending an indication to the UE to reduce a rate of communicating CSF in response to obtaining the one or more parameters.

Clause 14: The method of any one of Clauses 1-13, wherein the at least one parameter comprises: a MCS, a PMI, a RI, or a combination thereof.

Clause 15: A method for wireless communications by an apparatus comprising: sending one or more parameters of a UE receiver, the one or more parameters indicating a digital representation of the UE receiver used to estimate a response of the UE receiver communicating on a communication channel having one or more channel characteristics: receiving at least one parameter for communicating on the communication channel, the at least one parameter based at least in part on the one or parameters and the one or more channel characteristics of the communication channel; and communicating on the communication channel in accordance with the at least one parameter.

Clause 16: The method of Clause 15, wherein the digital representation comprises a machine learning model configured to estimate the response of the UE receiver, and wherein the one or more parameters comprise one or more coefficients for the machine learning model.

Clause 17: The method of any one of Clauses 15-16, wherein the one or more parameters comprise a receiver index indicating a receiver architecture of the UE receiver.

Clause 18: The method of Clause 17, wherein the receiver architecture comprises one or more of: a channel estimation type or a demodulator type.

Clause 19: The method of Clause 18, wherein the channel estimation type comprises one or more of: frequency domain MMSE-based channel estimation, or time domain MMSE-based channel estimation.

Clause 20: The method of Clause 18, wherein the demodulator type comprises one or more of: a MMSE-based demodulator, or a maximum likelihood-based demodulator.

Clause 21: The method of Clause 17, wherein the one or more parameters further comprise a number of receive antennas of the UE.

Clause 22: The method of any one of Clauses 15-21, further comprising sending a reference signal on the communication channel.

Clause 23: The method of any one of Clauses 15-22, wherein sending the one or more parameters comprises sending the one or more parameters prior to RRC connection establishment between the apparatus and the UE.

Clause 24: The method of any one of Clauses 15-23, further comprising: obtaining an indication to reduce a rate of communicating CSF in response to sending the one or more parameters.

Clause 25: The method of any one of Clauses 15-24, wherein the at least one parameter comprises: a MCS, a PMI, a RI, or a combination thereof.

Clause 26: One or more apparatuses, comprising: one or more memories comprising executable instructions; and one or more processors configured to execute the executable instructions and cause the one or more apparatuses to perform a method in accordance with any one of clauses 1-25.

Clause 27: One or more apparatuses, comprising means for performing a method in accordance with any one of clauses 1-25.

Clause 28: One or more non-transitory computer-readable media comprising executable instructions that, when executed by one or more processors of one or more apparatuses, cause the one or more apparatuses to perform a method in accordance with any one of clauses 1-25.

Clause 29: One or more computer program products embodied on one or more computer-readable storage media comprising code for performing a method in accordance with any one of clauses 1-25.

### Additional Considerations

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the general principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various actions may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

The various illustrative logical blocks, modules and circuits described in connection with the present disclosure may be implemented or performed with a general purpose processor, an AI processor, a digital signal processor (DSP), an ASIC, a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, a system on a chip (SoC), or any other such configuration.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

As used herein, “coupled to” and “coupled with” generally encompass direct coupling and indirect coupling (e.g., including intermediary coupled aspects) unless stated otherwise. For example, stating that a processor is coupled to a memory allows for a direct coupling or a coupling via an intermediary aspect, such as a bus.

The methods disclosed herein comprise one or more actions for achieving the methods. The method actions may be interchanged with one another without departing from the scope of the claims. In other words, unless a specific order of actions is specified, the order and/or use of specific actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor.

The following claims are not intended to be limited to the aspects shown herein, but are to be accorded the full scope consistent with the language of the claims. Reference to an element in the singular is not intended to mean only one unless specifically so stated, but rather “one or more.” The subsequent use of a definite article (e.g., “the” or “said”) with an element (e.g., “the processor”) is not intended to invoke a singular meaning (e.g., “only one”) on the element unless otherwise specifically stated. For example, reference to an element (e.g., “a processor,” “a controller,” “a memory,” “a transceiver,” “an antenna,” “the processor,” “the controller,” “the memory,” “the transceiver,” “the antenna,” etc.), unless otherwise specifically stated, should be understood to refer to one or more elements (e.g., “one or more processors,” “one or more controllers,” “one or more memories,” “one more transceivers,” etc.). The terms “set” and “group” are intended to include one or more elements, and may be used interchangeably with “one or more.” Where reference is made to one or more elements performing functions (e.g., steps of a method), one element may perform all functions, or more than one element may collectively perform the functions. When more than one element collectively performs the functions, each function need not be performed by each of those elements (e.g., different functions may be performed by different elements) and/or each function need not be performed in whole by only one element (e.g., different elements may perform different sub-functions of a function). Similarly, where reference is made to one or more elements configured to cause another element (e.g., an apparatus) to perform functions, one element may be configured to cause the other element to perform all functions, or more than one element may collectively be configured to cause the other element to perform the functions. Unless specifically stated otherwise, the term “some” refers to one or more. All structural and functional equivalents to the elements of the various aspects described throughout this disclosure that are known or later come to be known to those of ordinary skill in the art are intended to be encompassed by the claims. Moreover, nothing disclosed herein is intended to be dedicated to the public regardless of whether such disclosure is explicitly recited in the claims.

What is claimed is:

1. An apparatus configured for wireless communications, comprising:
one or more memories; and
one or more processors coupled to the one or more memories, the one or more processors being configured to cause the apparatus to:
obtain, from a user equipment (UE), one or more parameters of a UE receiver;
determine one or more channel characteristics of a communication channel between the apparatus and the UE based on a measurement of a signal received from the UE;
estimate a response of the UE receiver communicating on the communication channel having the one or more channel characteristics based on a digital representation of the UE receiver, wherein the digital representation of the UE receiver is based on the one or more parameters of the UE receiver;
determine, based on the estimated response, at least one parameter for communication on the communication channel with the UE;
send, to the UE, an indication of the at least one parameter; and
communicate with the UE in accordance with the at least one parameter.

2. The apparatus of claim 1, wherein the digital representation comprises a machine learning model configured to estimate the response of the UE receiver, and wherein the one or more parameters comprise one or more coefficients for the machine learning model.

3. The apparatus of claim 2, wherein, to estimate the response of the UE receiver, the one or more processors are configured to further cause the apparatus to:
provide, to the machine learning model, input comprising the one or more channel characteristics; and
obtain, from the machine learning model, output comprising the estimated response.

4. The apparatus of claim 3, wherein the estimated response comprises an indication of mutual information decoded via the digital representation of the UE receiver.

5. The apparatus of claim 2, wherein, to estimate the response of the UE receiver, the one or more processors are configured to further cause the apparatus to:
provide, to the machine learning model, input comprising one or more combinations of inputs, each of the one or more combinations of inputs comprising the one or more channel characteristics and one or more of a respective modulation and coding scheme (MCS), a respective precoding matrix indicator (PMI), or a respective rank indicator (RI); and
for each of the one or more combinations of inputs, obtain, from the machine learning model, output comprising an indication of whether the respective combination of inputs passes a cyclic redundancy check (CRC) as the estimated response.

6. The apparatus of claim 5, wherein the at least one parameter comprises the one or more of the respective MCS, the respective PMI, or the respective RI of one of the one or more combinations of inputs that would pass the CRC.

7. The apparatus of claim 1, wherein the one or more parameters comprise a receiver index indicating a receiver architecture of the UE receiver.

8. The apparatus of claim 7, wherein the receiver architecture comprises one or more of: a channel estimation type or a demodulator type.

9. The apparatus of claim 8, wherein the channel estimation type comprises one or more of:
frequency domain minimum mean square error (MMSE)-based channel estimation, or
time domain MMSE-based channel estimation.

10. The apparatus of claim 8, wherein the demodulator type comprises one or more of:
a minimum mean square error (MMSE)-based demodulator, or
a maximum likelihood-based demodulator.

11. The apparatus of claim 7, wherein the one or more parameters further comprise a number of receive antennas of the UE.

12. The apparatus of claim 1, wherein to obtain the one or more parameters, the one or more processors are configured to further cause the apparatus to obtain the one or more parameters prior to radio resource control (RRC) connection establishment between the apparatus and the UE.

13. The apparatus of claim 1, wherein the one or more processors are further configured to cause the apparatus to:
send an indication to the UE to reduce a rate of communicating channel state feedback (CSF) in response to obtaining the one or more parameters.

14. The apparatus of claim 1, wherein the at least one parameter comprises:
a modulation and coding scheme (MCS),
a precoding matrix indicator (PMI),
a rank indicator (RI), or
a combination thereof.

15. An apparatus configured for wireless communications, comprising:
one or more memories; and
one or more processors coupled to the one or more memories, the one or more processors being configured to cause the apparatus to:
send one or more parameters of a user equipment (UE) receiver, the one or more parameters indicating a digital representation of the UE receiver used to estimate a response of the UE receiver communicating on a communication channel having one or more channel characteristics;
receive at least one parameter for communicating on the communication channel, the at least one parameter based at least in part on the one or parameters and the one or more channel characteristics of the communication channel; and
communicate on the communication channel in accordance with the at least one parameter.

16. The apparatus of claim 15, wherein the digital representation comprises a machine learning model configured to estimate the response of the UE receiver, and wherein the one or more parameters comprise one or more coefficients for the machine learning model.

17. The apparatus of claim 15, wherein the one or more parameters comprise a receiver index indicating a receiver architecture of the UE receiver.

18. The apparatus of claim 17, wherein the receiver architecture comprises one or more of: a channel estimation type or a demodulator type.

19. The apparatus of claim 18, wherein the channel estimation type comprises one or more of:
frequency domain minimum mean square error (MMSE)-based channel estimation, or
time domain MMSE-based channel estimation.

20. The apparatus of claim 18, wherein the demodulator type comprises one or more of:
a minimum mean square error (MMSE)-based demodulator, or
a maximum likelihood-based demodulator.

21. The apparatus of claim 17, wherein the one or more parameters further comprise a number of receive antennas of the UE.

22. The apparatus of claim 15, wherein the one or more processors are further configured to cause the apparatus to send a reference signal on the communication channel.

23. The apparatus of claim 15, wherein to send the one or more parameters, the one or more processors are configured to further cause the apparatus to send the one or more parameters prior to radio resource control (RRC) connection establishment between the apparatus and the UE.

24. The apparatus of claim 15, wherein the one or more processors are further configured to cause the apparatus to:
obtain an indication to reduce a rate of communicating channel state feedback (CSF) in response to sending the one or more parameters.

25. The apparatus of claim 15, wherein the at least one parameter comprises:
a modulation and coding scheme (MCS),
a precoding matrix indicator (PMI),
a rank indicator (RI), or
a combination thereof.

26. A method for wireless communications by an apparatus, comprising:
obtaining, from a user equipment (UE), one or more parameters of a UE receiver;
determining one or more channel characteristics of a communication channel between the apparatus and the UE based on a measurement of a signal received from the UE;
estimating a response of the UE receiver communicating on the communication channel having the one or more channel characteristics based on a digital representation of the UE receiver, wherein the digital representation of the UE receiver is based on the one or more parameters of the UE receiver;
determining, based on the estimated response, at least one parameter for communication on the communication channel with the UE;
sending, to the UE, an indication of the at least one parameter; and
communicating with the UE in accordance with the at least one parameter.

27. A method for wireless communications by an apparatus comprising:
sending one or more parameters of a user equipment (UE) receiver, the one or more parameters indicating a digital representation of the UE receiver used to estimate a response of the UE receiver communicating on a communication channel having one or more channel characteristics;
receiving at least one parameter for communicating on the communication channel, the at least one parameter based at least in part on the one or parameters and the one or more channel characteristics of the communication channel; and
communicating on the communication channel in accordance with the at least one parameter.
